(19) United States
(12) Patent Application Publication
(10) Pub. No.: US 2026/0352277 A1
(43) Pub. Date: Nov. 5, 2026

(54) COMMUNICATION METHOD AND COMMUNICATION APPARATUS

(71) Applicant: HUAWEI TECHNOLOGIES CO., LTD., Shenzhen (CN)

(72) Inventors: Yong Liu, Shanghai (CN); Xiaoyan Bi, Shanghai (CN); Xiaojun Xi, Shenzhen (CN)

(73) Assignee: HUAWEI TECHNOLOGIES CO., LTD., Shenzhen (CN)

(21) Appl. No.: 19/720,861

(22) Filed: Jun. 25, 2026

Related U.S. Application Data
(63) Continuation of application No. PCT/CN2025/071498, filed on Jan. 9, 2025.

(30) Foreign Application Priority Data
Jan. 19, 2024 (CN) 202410083366.3

(51) Int. Cl. H04B 7/06; H04B 7/04; H04B 17/309; H04L 5/00

(52) U.S. Cl. CPC H04B 7/0617; H04B 7/04013; H04B 17/346; H04L 5/0051

(57) ABSTRACT

This application provides a communication method and a communication apparatus. In the method, a meta-surface directly covers a first apparatus, or covers the vicinity of the first apparatus in the near field with an extremely small spacing. A plurality of propagation paths are separated by using a reflection characteristic of the meta-surface, or spatial isolation of the plurality of propagation paths is improved. The first apparatus receives a first reference signal from a second apparatus via the meta-surface, and performs rank enhancement channel measurement based on the first reference signal, to obtain channel measurement information between the first apparatus and the second apparatus; and sends first indication information to the second apparatus, where the first indication information indicates at least one of multipath angular spread information or multipath angle information, or indicates a rank enhancement effective mode and a rank enhancement effective threshold.

### CROSS-REFERENCE TO RELATED APPLICATIONS

This application is a continuation of International Application No. PCT/CN2025/071498, filed on Jan. 9, 2025, which claims priority to Chinese Patent Application No. 202410083366.3, filed on Jan. 19, 2024. The disclosures of the aforementioned applications are hereby incorporated by reference in their entireties.

### TECHNICAL FIELD

This application relates to the field of communication technologies, and in particular, to a communication method and a communication apparatus.

### BACKGROUND

A meta-surface is a smart panel including a plurality of antenna elements, and each antenna element is a passive reflection device. Radio channel fading can be controlled and a desired directional beam can be formed by flexibly configuring an amplitude and a phase of each antenna element. Common application scenarios of the meta-surface include coverage enhancement and blind-spot coverage, and another application scenario currently under discussion is a rank enhancement scenario. For example, in the rank enhancement scenario, more gain-controllable transmission paths may be provided based on the meta-surface, and a network (for example, a radio access network (RAN)) or a base station may actively control radio channel quality (for example, enhance a link gain and increase a quantity of eigen subchannels) between the base station and user equipment (UE) via the meta-surface. In a possible rank enhancement solution, the meta-surface serves as an intermediate node to present a forwarding function similar to relay or integrated access and backhaul (IAB). However, in a scenario in which the meta-surface serves as an intermediate node, a signal-to-noise ratio (SNR) performance gain of a user does not decrease sharply only when quality of a direct channel is poor or channel gains of cascaded channels and a direct channel are comparable. Consequently, gain scenarios of the existing rank enhancement solution are restricted.

### SUMMARY

This application provides a communication method and a communication apparatus. In the method, a transmission rank can be improved based on a meta-surface and a difference between responses for different multipath angles, so that a system capacity is improved.

According to a first aspect, this application provides a communication method. The method is performed by a first apparatus. For example, the first apparatus may be a network device (for example, a base station), or may be a component (for example, a processor, a chip, or a chip system) of the network device, or may be a logical module that can implement all or a part of functions of the network device. For another example, the first apparatus may be a terminal, or a communication module in the terminal, or a circuit or a chip (for example, a modem chip, also referred to as a baseband chip, or a system-on-a-chip (SoC) chip or a system in package (SIP) chip including a modem core) that is responsible for a communication function in the terminal. Optionally, when the first apparatus is a network device, a second apparatus is a terminal; or when the first apparatus is a terminal, the second apparatus is a network device. The first apparatus receives a first reference signal from the second apparatus via a meta-surface, and performs rank enhancement channel measurement based on the first reference signal, to obtain channel measurement information between the first apparatus and the second apparatus, where the channel measurement information includes at least one of multipath angular spread information or multipath angle information. The first apparatus sends first indication information to the second apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information. Optionally, the first reference signal and an identity weighting coefficient matrix of the meta-surface are used by the first apparatus to perform the rank enhancement channel measurement.

In the method, the first apparatus includes the meta-surface. For example, the meta-surface may be a surface material layer having one or more functions of reflection, transmission, and refraction. The surface material layer is attached to an antenna or an antenna panel of the first apparatus, and is used to implement rank enhancement. For example, the meta-surface has different reflection/refraction/transmission coefficients (or referred to as different responses) for different incident angles. Therefore, an included angle between two outgoing paths may become large after two incident paths with a small included angle pass through the meta-surface, so that spatial isolation between the two paths is improved, and a channel transmission rank is improved (more data flows can be supported). In comparison with the meta-surface being separately deployed (for example, the meta-surface serves as a relay for forwarding between the first apparatus and the second apparatus), the meta-surface directly covers the first apparatus, or covers the vicinity of the first apparatus in the near field with an extremely small spacing. A plurality of propagation paths are separated by using a reflection characteristic of the meta-surface, or spatial isolation of the plurality of propagation paths is improved. In addition, the first apparatus or the second apparatus may obtain information such as the multipath angular spread information and the multipath angle information through rank enhancement channel measurement, and the first apparatus and the second apparatus may exchange whether the rank is enhanced and a rank enhancement effective interval in an explicit or implicit manner (for example, exchange at least one of the multipath angular spread information or the multipath angle information, or exchange information such as the rank enhancement effective mode and the rank enhancement effective threshold), so that the transmission rank can be improved based on the meta-surface and a difference between responses for different multipath angles, and a system capacity can be improved.

In a possible implementation, the first information is related to a first mapping relationship, a second mapping relationship, or a third mapping relationship. The first information includes at least one piece of multipath angular spread information, and the first mapping relationship includes a plurality of rank enhancement effective modes and a plurality of rank enhancement effective thresholds corresponding to a plurality of pieces of multipath angular spread information. The first information includes at least one group of multipath angular spread information and multipath angle information, and the second mapping relationship includes a plurality of rank enhancement effective modes and a plurality of rank enhancement effective thresholds corresponding to a plurality of groups of multipath angular spread information and multipath angle information. The first information includes at least one group of multipath angular spread information and multipath angle information, and a transmit antenna dimension of the first reference signal, and the third mapping relationship includes a plurality of rank enhancement effective modes and a plurality of rank enhancement effective thresholds corresponding to a plurality of groups of multipath angular spread information and multipath angle information, and the transmit antenna dimension of the first reference signal. Optionally, based on the first mapping relationship, the second mapping relationship, or the third mapping relationship, it can be deduced that the rank enhancement effective mode and the rank enhancement effective threshold are related to at least one of the multipath angular spread information or the multipath angle information.

In this implementation, a relationship between the rank enhancement effective mode, the rank enhancement effective threshold, the multipath angular spread information, the multipath angle information, and the transmit antenna dimension of the first reference signal is defined, for example, may be a predefined mapping relationship (for example, the first mapping relationship, the second mapping relationship, or the third mapping relationship), and it is assumed that both the first apparatus and the second apparatus can predefine the mapping relationship. Both the first apparatus and the second apparatus can determine the corresponding rank enhancement effective interval based on the foregoing mapping relationship, so that the transmission rank can be improved based on the meta-surface and the difference between the responses for the different multipath angles, and the system capacity can be improved.

In a possible implementation, the first information is related to a first function relationship, a second function relationship, or a third function relationship. The first information includes at least one piece of multipath angular spread information, an input parameter of the first function relationship includes the multipath angular spread information, and output parameters of the first function relationship include the rank enhancement effective mode and the rank enhancement effective threshold. The first information includes at least one group of multipath angular spread information and multipath angle information, input parameters of the second function relationship include the multipath angular spread information and the multipath angle information, and output parameters of the second function relationship include the rank enhancement effective mode and the rank enhancement effective threshold. The first information includes at least one group of multipath angular spread information and multipath angle information, and a transmit antenna dimension of the first reference signal, input parameters of the third function relationship include the multipath angular spread information, the multipath angle information, and the transmit antenna dimension of the first reference signal, and output parameters of the third function relationship include the rank enhancement effective mode and the rank enhancement effective threshold. Optionally, based on the first function relationship, the second function relationship, or the third function relationship, it can be deduced that the rank enhancement effective mode and the rank enhancement effective threshold are related to at least one of the multipath angular spread information or the multipath angle information.

In this implementation, a function relationship satisfied by the multipath angular spread information, the multipath angle information, and the transmit antenna dimension is defined, and it is assumed that both the first apparatus and the second apparatus can predefine the function relationship. Both the first apparatus and the second apparatus can determine the corresponding rank enhancement effective interval based on the foregoing function relationship, so that the transmission rank can be improved based on the meta-surface and the difference between the responses for the different multipath angles, and the system capacity can be improved.

In a possible implementation, the rank enhancement effective threshold includes a channel quality indicator index threshold or a modulation and coding scheme index threshold. One group of channel quality indicator index thresholds or modulation and coding scheme index thresholds corresponds to one group of signal-to-noise ratio thresholds, one group of signal-to-interference-plus-noise ratio thresholds, or one group of reference signal received power thresholds.

In this implementation, when the rank enhancement effective threshold includes the channel quality indicator index threshold or the modulation and coding scheme index threshold, it indicates that the first apparatus only needs to receive a channel quality indicator (CQI) based on channel state information (CSI) feedback information within a rank enhancement measurement periodicity, and does not need to newly define a rank enhancement effective mode and a rank enhancement effective threshold and receive the rank enhancement effective mode and the rank enhancement effective threshold.

In a possible implementation, the rank enhancement effective mode indicates that a rank enhancement effective interval is an open interval or a closed interval, and the rank enhancement effective mode is indicated by at least two bits.

In this implementation, the rank enhancement effective mode indicates that the rank enhancement effective interval is an open interval or a closed interval. For example, the open interval may be a unilateral open interval (for example, [, Δ₁] or [Δ₂,]) or a bilateral open interval (for example, [, Δ₁]∪[Δ₂,]), and the closed interval may be represented as [Δ₁,Δ₂]. If the foregoing four cases exist, at least two bits may be used for indication.

In a possible implementation, the rank enhancement effective threshold includes at least one of a maximum value or a minimum value of the rank enhancement effective interval; or the rank enhancement effective threshold includes a first value and a duration unit length, and the first value and the duration unit length are used to determine at least one of a maximum value or a minimum value of the rank enhancement effective interval.

In this implementation, the rank enhancement effective threshold may indicate only the maximum value or the minimum value of the rank enhancement effective interval (for example, may indicate only the maximum value or the minimum value when the rank enhancement effective interval is an open interval), or may indicate the maximum value and the minimum value of the rank enhancement effective interval (for example, need to indicate the maximum value and the minimum value when the rank enhancement effective interval is a closed interval). Optionally, the rank enhancement effective interval may alternatively be determined based on the first value (for example, a fixed threshold) and the duration unit length. For example, a first operation (for example, an operation like addition, subtraction, multiplication, or division) is performed on the fixed threshold and the duration unit length, to obtain the maximum value and/or the minimum value of the rank enhancement effective interval.

In a possible implementation, the meta-surface is weighted by using the identity weighting coefficient matrix, and a state of the identity weighting coefficient matrix of the meta-surface is a meta-surface default state. Performing the rank enhancement channel measurement by the first apparatus based on the first reference signal may be determining the channel measurement information based on the identity weighting coefficient matrix of the meta-surface and the first reference signal.

In this implementation, when the meta-surface of the first apparatus is used to perform the rank enhancement channel measurement, the meta-surface is weighted by using the identity weighting coefficient matrix. In addition, when the first apparatus performs the rank enhancement channel measurement, the state of the identity weighting coefficient matrix is the meta-surface default state, so that the first apparatus can perform the rank enhancement channel measurement based on the identity weighting coefficient matrix of the meta-surface and the first reference signal.

In a possible implementation, the first apparatus updates the weighting coefficient matrix of the meta-surface based on the first indication information.

In this implementation, the first apparatus may further update the weighting coefficient matrix of the meta-surface. For example, a vector or a matrix of a corresponding phase (the vector or the matrix of the phase belongs to the weighting coefficient matrix of the meta-surface) is updated based on information such as the multipath angular spread information or the multipath angle information.

In a possible implementation, a measurement periodicity of the rank enhancement channel measurement is determined based on a variation state of a multipath angle. The measurement periodicity of the rank enhancement channel measurement is greater than or equal to a measurement periodicity for a second reference signal, and a signal type of the second reference signal is the same as or different from a signal type of the first reference signal.

In this implementation, the rank enhancement channel measurement may be independent of a channel state information CSI measurement process, and the measurement periodicity of the rank enhancement channel measurement is greater than or equal to (usually greater than) a channel state information CSI measurement periodicity. Optionally, the measurement periodicity of the rank enhancement channel measurement includes an entire period of rank enhancement channel measurement and feedback. Similarly, the CSI measurement periodicity includes an entire period of CSI measurement and feedback.

According to a second aspect, this application provides a communication method. The method is performed by a first apparatus. For example, the first apparatus may be a network device (for example, a base station), or may be a component (for example, a processor, a chip, or a chip system) of the network device, or may be a logical module that can implement all or a part of functions of the network device. For another example, the first apparatus may be a terminal, or a communication module in the terminal, or a circuit or a chip (for example, a modem chip, also referred to as a baseband chip, or a SoC or SIP chip including a modem core) that is responsible for a communication function in the terminal. Optionally, when the first apparatus is a network device, a second apparatus is a terminal; or when the first apparatus is a terminal, the second apparatus is a network device. The first apparatus sends a first reference signal and an identity weighting coefficient matrix of a meta-surface to the second apparatus via the meta-surface, where the first reference signal and the identity weighting coefficient matrix of the meta-surface are used by the second apparatus to perform rank enhancement channel measurement. The first apparatus receives first indication information from the second apparatus, where the first indication information indicates at least one of first information or second information. The first information includes at least one of multipath angular spread information or multipath angle information. The at least one of the multipath angular spread information or the multipath angle information is obtained by the second apparatus by performing the rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information.

In the method, the first apparatus includes the meta-surface. In comparison with the meta-surface being separately deployed (for example, the meta-surface serves as a relay for forwarding between the first apparatus and the second apparatus), the meta-surface directly covers the first apparatus, or covers the vicinity of the first apparatus in the near field with an extremely small spacing. A plurality of propagation paths are separated by using a reflection characteristic of the meta-surface, or spatial isolation of the plurality of propagation paths is improved. In addition, the first apparatus and the second apparatus may exchange whether a rank is enhanced and a rank enhancement effective interval in an explicit or implicit manner (for example, exchange at least one of the multipath angular spread information or the multipath angle information, or exchange information such as the rank enhancement effective mode and the rank enhancement effective threshold), so that a transmission rank can be improved based on the meta-surface and a difference between responses for different multipath angles, and a system capacity can be improved.

In a possible implementation, the first information is related to a first mapping relationship, a second mapping relationship, or a third mapping relationship. The first information includes at least one piece of multipath angular spread information, and the first mapping relationship includes a plurality of rank enhancement effective modes and a plurality of rank enhancement effective thresholds corresponding to a plurality of pieces of multipath angular spread information. The first information includes at least one group of multipath angular spread information and multipath angle information, and the second mapping relationship includes a plurality of rank enhancement effective modes and a plurality of rank enhancement effective thresholds corresponding to a plurality of groups of multipath angular spread information and multipath angle information. The first information includes at least one group of multipath angular spread information and multipath angle information, and a transmit antenna dimension of the first reference signal, and the third mapping relationship includes a plurality of rank enhancement effective modes and a plurality of rank enhancement effective thresholds corresponding to a plurality of groups of multipath angular spread information and multipath angle information, and the transmit antenna dimension of the first reference signal. Optionally, based on the first mapping relationship, the second mapping relationship, or the third mapping relationship, it can be deduced that the rank enhancement effective mode and the rank enhancement effective threshold are related to at least one of the multipath angular spread information or the multipath angle information.

In a possible implementation, when the first information includes at least one of the multipath angular spread information or the multipath angle information, the first apparatus obtains, based on at least one of the multipath angular spread information or the multipath angle information, the rank enhancement effective mode and the rank enhancement effective threshold that correspond to the first information from at least one of the preset first mapping relationship, second mapping relationship, or third mapping relationship.

In the foregoing implementation, if the first indication information indicates at least one of the multipath angular spread information or the multipath angle information, the first apparatus may determine, based on a preset mapping relationship (the first mapping relationship, the second mapping relationship, or the third mapping relationship), for example, through table lookup, the rank enhancement effective mode and the rank enhancement effective threshold that correspond to the multipath angular spread information and/or the multipath angle information.

In a possible implementation, the first information is related to a first function relationship, a second function relationship, or a third function relationship. The first information includes at least one piece of multipath angular spread information, an input parameter of the first function relationship includes the multipath angular spread information, and output parameters of the first function relationship include the rank enhancement effective mode and the rank enhancement effective threshold. The first information includes at least one group of multipath angular spread information and multipath angle information, input parameters of the second function relationship include the multipath angular spread information and the multipath angle information, and output parameters of the second function relationship include the rank enhancement effective mode and the rank enhancement effective threshold. The first information includes at least one group of multipath angular spread information and multipath angle information, and a transmit antenna dimension of the first reference signal, input parameters of the third function relationship include the multipath angular spread information, the multipath angle information, and the transmit antenna dimension of the first reference signal, and output parameters of the third function relationship include the rank enhancement effective mode and the rank enhancement effective threshold. Optionally, based on the first function relationship, the second function relationship, or the third function relationship, it can be deduced that the rank enhancement effective mode and the rank enhancement effective threshold are related to at least one of the multipath angular spread information or the multipath angle information.

In a possible implementation, when the first information includes at least one of the multipath angular spread information or the multipath angle information, the first apparatus uses at least one of the multipath angular spread information or the multipath angle information as an input parameter of a function, and obtains, with reference to at least one of the preset first function relationship, second function relationship, or third function relationship, output parameters of the function, where the output parameters include the rank enhancement effective mode and the rank enhancement effective threshold that correspond to the first information.

In the foregoing implementation, if the first indication information indicates at least one of the multipath angular spread information or the multipath angle information, the first apparatus may determine, based on a preset function relationship (the first function relationship, the second function relationship, or the third function relationship), the rank enhancement effective mode and the rank enhancement effective threshold that correspond to the multipath angular spread information and/or the multipath angle information.

Optionally, for another possible implementation of the second aspect, refer to descriptions corresponding to another possible implementation of the first aspect, for example, descriptions of the first information and the second information. Details are not described herein again. Optionally, for effects that can be implemented in another possible implementation of the second aspect, refer to descriptions of effects that can be implemented in another possible implementation of the first aspect. Details are not described herein again.

According to a third aspect, this application provides a communication method. The method is performed by a second apparatus. For example, the second apparatus may be a network device (for example, a base station), or may be a component (for example, a processor, a chip, or a chip system) of the network device, or may be a logical module that can implement all or a part of functions of the network device. For another example, the second apparatus may be a terminal, or a communication module in the terminal, or a circuit or a chip (for example, a modem chip, also referred to as a baseband chip, or a SoC or SIP chip including a modem core) that is responsible for a communication function in the terminal. Optionally, when the second apparatus is a network device, a first apparatus is a terminal; or when the second apparatus is a terminal, the first apparatus is a network device. The second apparatus sends a first reference signal to the first apparatus. The second apparatus receives first indication information from the first apparatus, where the first indication information indicates at least one of first information or second information. The first information includes at least one of multipath angular spread information or multipath angle information. The at least one of the multipath angular spread information or the multipath angle information is obtained by the first apparatus by performing rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information. Optionally, the first apparatus includes a meta-surface, and the at least one of the multipath angular spread information or the multipath angle information is obtained by the first apparatus by performing the rank enhancement channel measurement based on the first reference signal and an identity weighting coefficient matrix of the meta-surface.

In the method, the second apparatus is a transmit end of the first reference signal, and the first apparatus is a receive end of the first reference signal. In addition, the first apparatus includes the meta-surface, and may perform the rank enhancement channel measurement based on the first reference signal, so that a rank enhancement effective interval can be fed back to the second apparatus. This helps the first apparatus and the second apparatus improve a transmission rank and improve a system capacity.

In a possible implementation, the first information is related to a first mapping relationship, a second mapping relationship, or a third mapping relationship. The first information includes at least one piece of multipath angular spread information, and the first mapping relationship includes a plurality of rank enhancement effective modes and a plurality of rank enhancement effective thresholds corresponding to a plurality of pieces of multipath angular spread information. The first information includes at least one group of multipath angular spread information and multipath angle information, and the second mapping relationship includes a plurality of rank enhancement effective modes and a plurality of rank enhancement effective thresholds corresponding to a plurality of groups of multipath angular spread information and multipath angle information. The first information includes at least one group of multipath angular spread information and multipath angle information, and a transmit antenna dimension of the first reference signal, and the third mapping relationship includes a plurality of rank enhancement effective modes and a plurality of rank enhancement effective thresholds corresponding to a plurality of groups of multipath angular spread information and multipath angle information, and the transmit antenna dimension of the first reference signal. Optionally, based on the first mapping relationship, the second mapping relationship, or the third mapping relationship, it can be deduced that the rank enhancement effective mode and the rank enhancement effective threshold are related to at least one of the multipath angular spread information or the multipath angle information.

In this implementation, a relationship between the rank enhancement effective mode, the rank enhancement effective threshold, the multipath angular spread information, the multipath angle information, and the transmit antenna dimension of the first reference signal is defined, for example, may be a predefined mapping relationship (for example, the first mapping relationship, the second mapping relationship, or the third mapping relationship), and it is assumed that both the first apparatus and the second apparatus can predefine the mapping relationship. Both the first apparatus and the second apparatus can determine the corresponding rank enhancement effective interval based on the foregoing mapping relationship, so that the transmission rank can be improved based on the meta-surface and a difference between responses for different multipath angles, and the system capacity can be improved.

In a possible implementation, when the first information includes at least one of the multipath angular spread information or the multipath angle information, the second apparatus obtains, based on at least one of the multipath angular spread information or the multipath angle information, the rank enhancement effective mode and the rank enhancement effective threshold that correspond to the first information from at least one of the preset first mapping relationship, second mapping relationship, or third mapping relationship.

In this implementation, if the first indication information indicates at least one of the multipath angular spread information or the multipath angle information, the second apparatus may determine, based on a preset mapping relationship (the first mapping relationship, the second mapping relationship, or the third mapping relationship), for example, through table lookup, the rank enhancement effective mode and the rank enhancement effective threshold that correspond to the multipath angular spread information and/or the multipath angle information.

In a possible implementation, the first information is related to a first function relationship, a second function relationship, or a third function relationship. The first information includes at least one piece of multipath angular spread information, an input parameter of the first function relationship includes the multipath angular spread information, and output parameters of the first function relationship include the rank enhancement effective mode and the rank enhancement effective threshold. The first information includes at least one group of multipath angular spread information and multipath angle information, input parameters of the second function relationship include the multipath angular spread information and the multipath angle information, and output parameters of the second function relationship include the rank enhancement effective mode and the rank enhancement effective threshold. The first information includes at least one group of multipath angular spread information and multipath angle information, and a transmit antenna dimension of the first reference signal, input parameters of the third function relationship include the multipath angular spread information, the multipath angle information, and the transmit antenna dimension of the first reference signal, and output parameters of the third function relationship include the rank enhancement effective mode and the rank enhancement effective threshold. Optionally, based on the first function relationship, the second function relationship, or the third function relationship, it can be deduced that the rank enhancement effective mode and the rank enhancement effective threshold are related to at least one of the multipath angular spread information or the multipath angle information.

In this implementation, a function relationship satisfied by the multipath angular spread information, the multipath angle information, and the transmit antenna dimension is defined, and it is assumed that both the first apparatus and the second apparatus can predefine the function relationship. Both the first apparatus and the second apparatus can determine the corresponding rank enhancement effective interval based on the foregoing function relationship, so that the transmission rank can be improved based on the meta-surface and a difference between responses for different multipath angles, and the system capacity can be improved.

In a possible implementation, when the first information includes at least one of the multipath angular spread information or the multipath angle information, the second apparatus uses at least one of the multipath angular spread information or the multipath angle information as an input parameter of a function, and obtains, with reference to at least one of the preset first function relationship, second function relationship, or third function relationship, output parameters of the function, where the output parameters include the rank enhancement effective mode and the rank enhancement effective threshold that correspond to the first information.

In this implementation, if the first indication information indicates at least one of the multipath angular spread information or the multipath angle information, the second apparatus may determine, based on a preset function relationship (the first function relationship, the second function relationship, or the third function relationship), the rank enhancement effective mode and the rank enhancement effective threshold that correspond to the multipath angular spread information and/or the multipath angle information.

In a possible implementation, the rank enhancement effective threshold includes a channel quality indicator index threshold or a modulation and coding scheme index threshold. One group of channel quality indicator index thresholds or modulation and coding scheme index thresholds corresponds to one group of signal-to-noise ratio thresholds, one group of signal-to-interference-plus-noise ratio thresholds, or one group of reference signal received power thresholds.

In this implementation, when the rank enhancement effective threshold includes the channel quality indicator index threshold or the modulation and coding scheme index threshold, it indicates that the first apparatus only needs to receive a CQI based on CSI feedback information within a rank enhancement measurement periodicity, and does not need to newly define a rank enhancement effective mode and a rank enhancement effective threshold and receive the rank enhancement effective mode and the rank enhancement effective threshold.

In a possible implementation, the rank enhancement effective mode indicates that a rank enhancement effective interval is an open interval or a closed interval, and the rank enhancement effective mode is indicated by at least two bits.

In this implementation, the rank enhancement effective mode indicates that the rank enhancement effective interval is an open interval or a closed interval. For example, the open interval may be a unilateral open interval (for example, [, Δ₁] or [Δ₂,]) or a bilateral open interval (for example, [, Δ₁]∪[Δ₂,]), and the closed interval may be represented as [Δ₁,Δ₂]. If the foregoing four cases exist, at least two bits may be used for indication.

In a possible implementation, the rank enhancement effective threshold includes at least one of a maximum value or a minimum value of the rank enhancement effective interval; or the rank enhancement effective threshold includes a first value and a duration unit length, and the first value and the duration unit length are used to determine at least one of a maximum value or a minimum value of the rank enhancement effective interval.

In this implementation, the rank enhancement effective threshold may indicate only the maximum value or the minimum value of the rank enhancement effective interval (for example, may indicate only the maximum value or the minimum value when the rank enhancement effective interval is an open interval), or may indicate the maximum value and the minimum value of the rank enhancement effective interval (for example, need to indicate the maximum value and the minimum value when the rank enhancement effective interval is a closed interval). Optionally, the rank enhancement effective interval may alternatively be determined based on the first value (for example, a fixed threshold) and the duration unit length. For example, a first operation (for example, an operation like addition, subtraction, multiplication, or division) is performed on the fixed threshold and the duration unit length, to obtain the maximum value and/or the minimum value of the rank enhancement effective interval.

In a possible implementation, a measurement periodicity of the rank enhancement channel measurement is determined based on a change status of a multipath angle. The measurement periodicity of the rank enhancement channel measurement is greater than or equal to a measurement periodicity for a second reference signal, and a signal type of the second reference signal is the same as or different from a signal type of the first reference signal.

In this implementation, the rank enhancement channel measurement may be independent of a channel state information CSI measurement process, and the measurement periodicity of the rank enhancement channel measurement is greater than or equal to (usually greater than) a channel state information CSI measurement periodicity. Optionally, the measurement periodicity of the rank enhancement channel measurement includes an entire period of rank enhancement channel measurement and feedback. Similarly, the CSI measurement periodicity includes an entire period of CSI measurement and feedback.

According to a fourth aspect, this application provides a communication method. The method is performed by a second apparatus. For example, the second apparatus may be a network device (for example, a base station), or may be a component (for example, a processor, a chip, or a chip system) of the network device, or may be a logical module that can implement all or a part of functions of the network device. For another example, the second apparatus may be a terminal, or a communication module in the terminal, or a circuit or a chip (for example, a modem chip, also referred to as a baseband chip, or a SoC or SIP chip including a modem core) that is responsible for a communication function in the terminal. Optionally, when the second apparatus is a network device, a first apparatus is a terminal; or when the second apparatus is a terminal, the first apparatus is a network device. The second apparatus receives a first reference signal and an identity weighting coefficient matrix of a meta-surface from the first apparatus, and performs rank enhancement channel measurement based on the first reference signal and the identity weighting coefficient matrix of the meta-surface, to obtain channel measurement information between the first apparatus and the second apparatus, where the channel measurement information includes at least one of multipath angular spread information or multipath angle information. The second apparatus sends first indication information to the first apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

In the method, the second apparatus is a receive end of the first reference signal, the first apparatus is a transmit end of the first reference signal, and the first apparatus includes the meta-surface. The second apparatus can perform, by receiving the first reference signal and the identity weighting coefficient matrix of the meta-surface, the rank enhancement channel measurement based on the first reference signal, so that a rank enhancement effective interval can be fed back to the first apparatus. This helps the first apparatus and the second apparatus improve a transmission rank and improve a system capacity.

Optionally, for another possible implementation of the fourth aspect, refer to descriptions corresponding to another possible implementation of the third aspect, for example, descriptions of the first information and the second information. Details are not described herein again. Optionally, for effects that can be implemented in another possible implementation of the fourth aspect, refer to descriptions of effects that can be implemented in another possible implementation of the third aspect. Details are not described herein again.

According to a fifth aspect, this application provides a communication apparatus. The communication apparatus may be a network device or a terminal, or a component (for example, a processor, a chip, or a chip system) of the network device or the terminal, or an apparatus that can be used together with the network device or the terminal. In a possible implementation, the communication apparatus has a function of implementing the first aspect. For example, the communication apparatus includes a corresponding module, unit, or means for performing an operation in the first aspect. The module, the unit, or the means may be implemented by using software, or may be implemented by using hardware, or may be implemented by using software in combination with hardware.

In a possible implementation, the communication apparatus includes a communication unit and a processing unit. The communication unit is configured to receive a first reference signal from a second apparatus via a meta-surface. The processing unit is configured to perform rank enhancement channel measurement based on the first reference signal, to obtain channel measurement information between a first apparatus and the second apparatus, where the channel measurement information includes at least one of multipath angular spread information or multipath angle information. The communication unit is further configured to send first indication information to the second apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

Optionally, for another possible implementation of the fifth aspect, refer to descriptions corresponding to another possible implementation of the first aspect. Details are not described herein again.

According to a sixth aspect, this application provides a communication apparatus. The communication apparatus may be a network device or a terminal, or a component (for example, a processor, a chip, or a chip system) of the network device or the terminal, or an apparatus that can be used together with the network device or the terminal. In a possible implementation, the communication apparatus has a function of implementing the second aspect. For example, the communication apparatus includes a corresponding module, unit, or means for performing an operation in the second aspect. The module, the unit, or the means may be implemented by using software, or may be implemented by using hardware, or may be implemented by using software in combination with hardware.

In a possible implementation, the communication apparatus includes a communication unit and a processing unit. The communication unit is configured to send a first reference signal to a second apparatus via a meta-surface. The communication unit is further configured to receive first indication information from the second apparatus, where the first indication information indicates at least one of first information or second information. The first information includes at least one of multipath angular spread information or multipath angle information. The at least one of the multipath angular spread information or the multipath angle information is obtained by the second apparatus by performing rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information.

Optionally, for another possible implementation of the sixth aspect, refer to descriptions corresponding to another possible implementation of the second aspect. Details are not described herein again.

According to a seventh aspect, this application provides a communication apparatus. The communication apparatus may be a network device or a terminal, or a component (for example, a processor, a chip, or a chip system) of the network device or the terminal, or an apparatus that can be used together with the network device or the terminal. In a possible implementation, the communication apparatus has a function of implementing the third aspect. For example, the communication apparatus includes a corresponding module, unit, or means for performing an operation in the third aspect. The module, the unit, or the means may be implemented by using software, or may be implemented by using hardware, or may be implemented by using software in combination with hardware.

In a possible implementation, the communication apparatus includes a communication unit and a processing unit. The communication unit is configured to send a first reference signal to a first apparatus. The communication unit is further configured to receive first indication information from the first apparatus, where the first indication information indicates at least one of first information or second information. The first information includes at least one of multipath angular spread information or multipath angle information. The at least one of the multipath angular spread information or the multipath angle information is obtained by the first apparatus by performing rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information.

Optionally, for another possible implementation of the seventh aspect, refer to descriptions corresponding to another possible implementation of the third aspect. Details are not described herein again.

According to an eighth aspect, this application provides a communication apparatus. The communication apparatus may be a network device or a terminal, or a component (for example, a processor, a chip, or a chip system) of the network device or the terminal, or an apparatus that can be used together with the network device or the terminal. In a possible implementation, the communication apparatus has a function of implementing the fourth aspect. For example, the communication apparatus includes a corresponding module, unit, or means for performing an operation in the fourth aspect. The module, the unit, or the means may be implemented by using software, or may be implemented by using hardware, or may be implemented by using software in combination with hardware.

In a possible implementation, the communication apparatus includes a communication unit and a processing unit. The communication unit is configured to receive a first reference signal from a first apparatus. The processing unit is configured to perform rank enhancement channel measurement based on the first reference signal, to obtain channel measurement information between the first apparatus and a second apparatus, where the channel measurement information includes at least one of multipath angular spread information or multipath angle information. The communication unit is further configured to send first indication information to the first apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

Optionally, for another possible implementation of the eighth aspect, refer to descriptions corresponding to another possible implementation of the fourth aspect. Details are not described herein again.

According to a ninth aspect, this application provides a communication apparatus. The communication apparatus includes a memory and one or more processors. The memory is configured to store a part or all of a computer program or instructions necessary for implementing a function in at least one of the first aspect, the second aspect, the third aspect, or the fourth aspect. The one or more processors may execute the computer program or the instructions. When the computer program or the instructions are executed, the communication apparatus is caused to implement at least one of the following: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect.

In a possible design, the communication apparatus may further include an interface circuit, and the processor is configured to communicate with another apparatus or component through the interface circuit.

In a possible design, the communication apparatus may further include the memory.

In a possible design, the communication apparatus may be a terminal, or a communication module in the terminal, or a chip, for example, a modem chip, or a SoC or SIP chip including a modem module that is responsible for a communication function in the terminal.

According to a tenth aspect, this application provides a communication apparatus, including a processor and an interface circuit. The interface circuit is configured to: receive a signal from another communication apparatus and transmit the signal to the processor, or send a signal from the processor to the another communication apparatus. The processor is configured to implement at least one of the following by using a logic circuit or executing code instructions: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect.

According to an eleventh aspect, this application provides a communication system. The communication system includes at least one apparatus or device in the fifth aspect to the tenth aspect, so that the at least one apparatus or device performs at least one of the following: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect.

According to a twelfth aspect, this application provides a computer-readable storage medium. The computer-readable storage medium stores a computer program or computer-readable instructions, and when the computer program or the computer-readable instructions are run on a computer, the computer is caused to perform at least one of the following: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect.

According to a thirteenth aspect, this application provides a computer program product. When a computer reads and executes the computer program product, the computer is caused to perform at least one of the following: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect.

According to a fourteenth aspect, this application provides a chip. The chip includes a processor (or a logic circuit). Optionally, the chip may further include a communication interface (or an interface), configured to implement at least one of the following: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect.

In a possible implementation, if the chip is a minimum processing unit in an entire system, the chip may be a processor, or may include a processor and a memory, or may include a processor, a memory, and a transceiver, and is configured to implement at least one of the following: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect.

According to a fifteenth aspect, this application provides a chip system. The chip system includes a processor and an interface. Optionally, the chip system may further include a memory, configured to implement at least one of the following: the method according to any one of the first aspect and the possible implementations of the first aspect, the method according to any one of the second aspect and the possible implementations of the second aspect, the method according to any one of the third aspect and the possible implementations of the third aspect, or the method according to any one of the fourth aspect and the possible implementations of the fourth aspect. The chip system may include a chip, or may include a chip and another discrete component.

### BRIEF DESCRIPTION OF DRAWINGS

FIG. 1A and FIG. 1B are diagrams of a communication system according to this application;

FIG. 2 is a diagram of a system of a rank enhancement solution;

FIG. 3 is a schematic flowchart of a communication method according to this application;

FIG. 4 is a diagram of multipath angle information and multipath angular spread information according to this application;

FIG. 5 is a diagram of a relationship between multipath angle information and a signal-to-noise ratio according to this application;

FIG. 6 is a schematic flowchart of another communication method according to this application;

FIG. 7 is a diagram of a channel capacity according to this application;

FIG. 8 is a diagram of a communication apparatus according to this application; and

FIG. 9 is a diagram of another communication apparatus according to this application.

### DESCRIPTION OF EMBODIMENTS

In embodiments of this application, “/” may represent an “or” relationship between associated objects, for example, A/B may represent A or B; and “and/or” may represent that there are three relationships between the associated objects, for example, A and/or B may represent the following three cases: Only A exists, both A and B exist, and only B exists, where A and B may be singular or plural.

In embodiments of this application, words such as “first” or “second” may be used to distinguish between technical features with same or similar functions. The words such as “first” and “second” do not limit a quantity and an execution sequence, and the words such as “first” and “second” do not limit a definite difference. In embodiments of this application, a word like “example” or “for example” is used to represent an example, an illustration, or a description. Any embodiment or design solution described as “example” or “for example” should not be explained as being more preferred or having more advantages than another embodiment or design solution. The word like “example” or “for example” is used to present a related concept in a specific manner for ease of understanding.

In embodiments of this application, “sending” and “receiving” represent signal transfer directions. For example, “sending information to a terminal” may be understood as a destination end of the information being the terminal device, and may include direct sending through an air interface, or indirect sending by another unit or module through an air interface. “Receiving information from a network device” may be understood as a source end of the information being the network device, and may include direct receiving from the network device through an air interface, or indirect receiving from the network device from another unit or module through an air interface. “Sending” may alternatively be understood as “outputting” of a chip interface, and “receiving” may alternatively be understood as “inputting” of the chip interface.

In other words, sending and receiving may be performed between devices, for example, between a network device and a terminal device; or may be performed inside a device, for example, sending or receiving between components, modules, chips, software modules, or hardware modules inside the device through a bus, a cable, or an interface.

It can be understood that necessary processing, for example, encoding or modulation, may be performed on information between a source end that sends the information and a destination end, but the destination end can understand valid information from the source end. Similar descriptions in this application may be understood similarly, and details are not described again.

In embodiments of this application, an “indication” may include a direct indication and an indirect indication, or may include an explicit indication and an implicit indication. Information indicated by specific information (for example, indication information in the following descriptions) is referred to as to-be-indicated information. In this case, during specific implementation, the to-be-indicated information may be indicated in a plurality of manners, for example, but not limited to: The to-be-indicated information may be directly indicated, for example, the to-be-indicated information or an index of the to-be-indicated information is indicated. Alternatively, the to-be-indicated information may be indirectly indicated by indicating other information, where there is an association relationship between the other information and the to-be-indicated information. Alternatively, only a part of the to-be-indicated information may be indicated, and a remaining part of the to-be-indicated information is known or pre-agreed upon. For example, specific information may be indicated by an arrangement sequence of a plurality of pieces of information that is pre-agreed upon (for example, predefined in a protocol), to reduce indication overheads to some extent. A specific indication manner is not limited in this application. It can be understood that, for a transmitter of the indication information, the indication information may indicate the to-be-indicated information, and for a receiver of the indication information, the indication information may be used to determine the to-be-indicated information.

The following describes technical solutions in embodiments of this application with reference to accompanying drawings in embodiments of this application.
I. For ease of understanding, the following describes in detail definitions of related nouns in this application.

### 1. Multiple Input Multiple Output (MIMO) System

In a MIMO technology, an array gain, multiplexing and diversity gains, and an interference cancellation gain in space can be obtained for a signal by using a resource in a space dimension without increasing a system bandwidth. This helps improve a capacity and spectrum efficiency of a communication system. For example, in a long term evolution (LTE) system, the system may use a plurality of antennas at a transmit end and a receive end to support transmission at up to eight layers. However, as people have increasingly higher communication requirements such as a high rate, high reliability, and low latency, a modern communication system continuously faces challenges of a larger capacity, wider coverage, and lower latency. These requirements also become key requirements of a next-generation communication system.

### 2. Reference Signal

In a demodulation process at the receive end of the communication system, in comparison with non-coherent demodulation, coherent demodulation has better performance. Therefore, the coherent demodulation is more widely used in the modern communication system. In an orthogonal frequency division multiplexing (OFDM) system, modulation of each carrier suppresses the carrier. Therefore, in the OFDM system, to implement coherent demodulation at the receive end, reference signals are needed. The reference signal is also referred to as a pilot signal or a reference signal (RS). The reference signals are distributed on different resource elements (REs) in two-dimensional space of time domain and frequency domain in an OFDM symbol, and have known amplitudes and phases.

Similarly, in the MIMO system, each transmit antenna (a virtual antenna or a physical antenna) has an independent data channel. A receiver performs channel estimation on each transmit antenna based on a preset RS signal, and restores sent data based on the channel estimation. The channel estimation is a process of reconstructing a received signal to compensate for channel fading and noise, and refers to tracking a time domain change and a frequency domain change of a channel by using an RS predicted by a transmitter and the receiver. For example, to implement channel quality measurement and data demodulation in a high-order multiple-antenna system, a plurality of reference signals are separately defined: a cell-specific reference signal (CRS), a demodulation reference signal (DMRS), a sounding reference signal (SRS), a channel state information-reference signal (CSI-RS), and the like. The DMRS is used to demodulate a physical downlink shared channel (PDSCH) or a physical uplink shared channel (PUSCH). The CSI-RS is used to measure channel information and report information such as a channel quality indicator (CQI), a precoding matrix indicator (PMI), and a rank indicator (RI).

### 3. Meta-Surface

### (1) Meaning of the Meta-Surface

In a complex evolution process of a wireless communication system, high throughput and massive connectivity are always a core challenge and a pursuit objective of a wireless communication network. To address the foregoing challenge, a reconfigurable intelligent surface (reconfigurable intelligent surface, RIS, also referred to as an intelligent reflecting surface (IRS), a large intelligent surface (LIS), or a meta-surface) has begun to be widely studied as a technology with great potential. For example, a RIS-assisted network that controls a channel feature by using a RIS element is considered a key enabling technology for expanding coverage of the wireless communication network.

Common application scenarios of the meta-surface are coverage enhancement and coverage hole filling. For example, one or more RISs are deployed at a cell edge or in a coverage hole caused by blocking or deep fading, so that the coverage can be extended and the coverage hole can be filled. Another possible application scenario of the RIS is rank enhancement. A principle of the rank enhancement is as follows: Based on the RIS, a channel may be actively changed, more gain-controllable transmission paths may be provided, and a network (RAN) or a base station (BS) may actively control radio channel quality (for example, enhance a link gain and increase a quantity of eigen subchannels) between the base station and a user equipment (UE) by using the RIS. For example, in comparison with a high frequency, a RIS-MIMO system at a centimeter-wave frequency (for example, 10 gigahertz (GHz)) has a lower path loss and more abundant scattering, and a quantity of antennas in a centimeter-wave band may be large, so that a higher spatial degree of freedom is provided. However, a physical environment, for example, multipath distribution, is not sufficient to support transmission of a large quantity of flows. Therefore, in addition to a coverage enhancement function, the rank enhancement may be one of potential main features of the centimeter-wave RIS-MIMO system.

### 4. Network Architecture

A communication method provided in this application may be applied to various communication systems. For example, the communication system may be a 5G (or referred to as a new radio (NR)) communication system, or may be a transition system between an LTE communication system and the 5G communication system, where the transition system may also be referred to as a 4.5G communication system. Certainly, the communication system may alternatively be a future communication system, for example, a 6th generation (6G) system, even a 7th generation (7G) system, or the like. A network architecture and a service scenario described in embodiments of this application are intended to describe the technical solutions in embodiments of this application more clearly, and do not constitute a limitation on the technical solutions provided in embodiments of this application. A person of ordinary skill in the art may know that with evolution of communication network architectures and emergence of new service scenarios, the technical solutions provided in embodiments of this application are also applicable to similar technical problems.

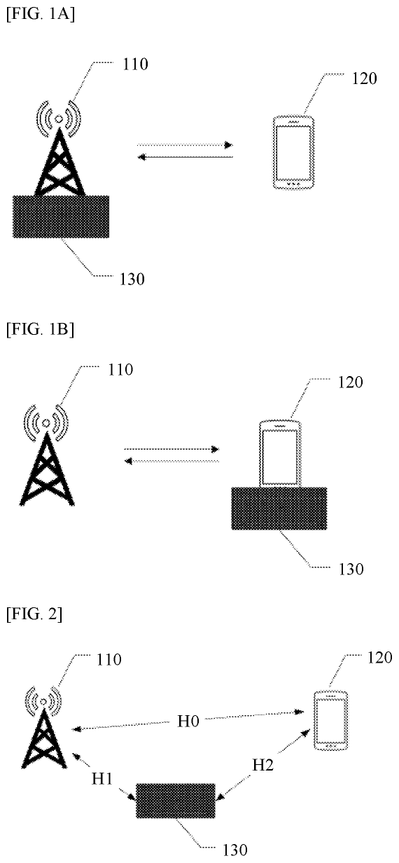

For example, FIG. 1A and FIG. 1B are diagrams of a communication system according to this application. The communication system includes at least one network device 110 and at least one terminal 120. The network device 110 and the terminal 120 may be connected to each other in a wireless manner. FIG. 1A and FIG. 1B are merely an example. A quantity of network devices and a quantity of terminals are not limited in this application. The communication system further includes a meta-surface 130, and it is assumed that the meta-surface 130 is on a surface of the network device 110 (as shown in FIG. 1A) or on a surface of the terminal 120 (as shown in FIG. 1B). For example, the meta-surface 130 may be a surface material layer having one or more functions of reflection, transmission, and refraction. The surface material layer is attached to an antenna of the network device 110 or the terminal 120, to implement rank enhancement (based on the meta-surface, a channel may be actively changed, and more gain-controllable transmission paths are provided based on a difference between responses for different multipath angles). Optionally, the meta-surface may also be represented as a reconfigurable intelligent surface (RIS), or may be referred to as an intelligent reflecting surface (IRS), a large intelligent surface (LIS), or any other name of the meta-surface. This is not limited in this application.

The following describes the network device and the terminal in this application.

The terminal may be a wireless terminal device that can receive scheduling information and indication information of the network device. The terminal may be a device that provides a user with voice and/or data connectivity, or a handheld device having a wireless connection function, or another processing device connected to a wireless modem. The terminal is also referred to as user equipment (UE), a mobile station (MS), a mobile terminal (MT), customer premises equipment (CPE), a terminal device, or the like. The terminal is a device that includes a wireless communication function (providing a user with voice/data connectivity), for example, the handheld device or a vehicle-mounted device having the wireless connection function. Currently, some examples of the terminal are: a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in an internet of vehicles, a wireless terminal in self driving, a wireless terminal in remote medical surgery, a wireless terminal in a smart grid, a wireless terminal in transportation safety, a wireless terminal in a smart city, a wireless terminal in a smart home, or the like. For example, the wireless terminal in the self-driving may be an uncrewed aerial vehicle, a helicopter, or an airplane. For example, the wireless terminal in the internet of vehicles may be a vehicle-mounted device, an entire vehicle device, a vehicle-mounted module, a vehicle, or a ship. The wireless terminal in the industrial control may be a camera, a robot, a robotic arm, or the like. The wireless terminal in the smart home may be a television, an air conditioner, a sweeper, a sound box, a set-top box, or the like.

It should be noted that the terminal may be a device or an apparatus with a chip, a device or an apparatus integrated with a circuit, or a chip, a chip system, a module, or a control unit in the device or the apparatus shown above. This is not specifically limited in this application. It should be noted that, in this application, reference to the terminal may mean the terminal, or may mean a chip, a functional module, an integrated circuit, or the like that completes the method provided in this application in the terminal. This is not specifically limited in this application.

The network device may be a device in a wireless network. For example, the network device may be a device that is deployed in a radio access network and that provides a wireless communication function for the terminal device. For example, the network device may be a radio access network (RAN) node that enables the terminal device to access the wireless network, and may also be referred to as an access network device, a RAN entity, an access node, a network node, a communication apparatus, or the like.

Specifically, the network device may be an access network device in a cellular system related to the 3rd generation partnership project (3GPP), for example, a 4G communication system or a 5G communication system. The network device may alternatively be an access network device in an open access network (open RAN, O-RAN, or ORAN) or a cloud radio access network (CRAN). Alternatively, the network device may be an access network device in a communication system obtained by integrating two or more of the foregoing communication systems.

The network device includes but is not limited to an evolved NodeB (eNB), a radio network controller (RNC), a NodeB (NodeB, NB), a base station controller (base station controller, BSC), a base transceiver station (BTS), a home base station (for example, a home evolved NodeB or a home NodeB, HNB), a baseband unit (BBU), an access point (AP) in a wireless fidelity (Wi-Fi) system, a macro base station, a micro base station, a wireless relay node, a donor node, a radio controller in a CRAN scenario, a wireless backhaul node, a transmission point (TP), a transmission reception point (TRP), or the like, or may be a network device in a 5G mobile communication system, for example, a next generation NodeB (gNB), a TRP, or a TP in an NR system, or one antenna panel or one group of antenna panels (including a plurality of antenna panels) of a base station in the 5G mobile communication system. Alternatively, the network device may be a network node that constitutes a gNB or a transmission point, for example, a central unit (CU), a distributed unit (DU), a central unit-control plane (CU-CP), a central unit-user plane (CU-UP), or a radio unit (RU). The CU and the DU may be separately disposed, or may be included in a same network element, for example, a BBU. The RU may be included in a radio frequency device or a radio frequency unit, for example, a remote radio unit (RRU), an active antenna unit (AAU), or a remote radio head (RRH). Alternatively, the network device may be a server, a wearable device, a vehicle, a vehicle-mounted device, or the like. For example, an access network device in a V2X technology may be a roadside unit (RSU).

It should be noted that in different systems, the CU (or the CU-CP and the CU-UP), the DU, or the RU may have different names, but a person skilled in the art may understand meanings of the names. For example, in an open radio access network (ORAN) system, the CU may also be referred to as an open central unit (O-CU) or an open CU, the DU may also be referred to as an open distributed unit (O-DU), the CU-CP may also be referred to as an open central unit-control plane (O-CU-CP), the CU-UP may also be referred to as an open central unit-user plane (O-CU-UP), and the RU may also be referred to as an open radio unit (O-RU). This is not specifically limited in this application. Any unit in the CU, the CU-CP, the CU-UP, the DU, and the RU in this application may be implemented by using a software module, a hardware module, or a combination of the software module and the hardware module.

Optionally, for network elements in the ORAN system, each network element may implement a protocol layer function shown in the following Table 1.

TABLE 1

| ORAN | |
|---|---|
| network | |
| element | Protocol layer function |
| O-CU-CP | Radio resource control (RRC) and packet data |
| | convergence protocol control plane (PDCP-C) |
| O-CU-UP | Service data adaptation protocol (service data |
| | adaptation protocol, SDAP) and packet data |
| | convergence protocol user plane (PDCP-U) |
| O-DU | Radio link control (radio link control, RLC), |
| | media access control (media access control, |
| | or medium access control, MAC), and high |
| | physical layer (PHY-high) |
| O-RU | Low physical layer (PHY-low) |

It should be noted that, in the ORAN system, the network device in this application may be one or more network elements in Table 1 above.

The following describes architectures of a CU and a DU of the access network device. The access network device includes at least one CU and at least one DU. Optionally, the access network device further includes at least one RU.

The following provides descriptions by using an example in which the access network device includes one CU and one DU. The CU has some functions of a core network, and the CU may include a CU-CP and a CU-UP. The CU and the DU may be configured based on protocol layer functions of a wireless network that are implemented by the CU and the DU. For example, the CU is configured to implement functions of a packet data convergence protocol (PDCP) layer and a protocol layer above the PDCP layer (for example, an RRC layer and/or an SDAP layer). The DU is configured to implement a function of a protocol layer below the PDCP layer (for example, an RLC layer, a MAC layer, and/or a physical (PHY) layer). For another example, the CU is configured to implement a function of a protocol layer above a PDCP layer (for example, an RRC layer and/or an SDAP layer), and the DU is configured to implement functions of the PDCP layer and a protocol layer below the PDCP layer (for example, an RLC layer, a MAC layer, and/or a PHY layer).

When the CU includes the CU-CP and the CU-UP, the CU-CP is configured to implement a control plane function of the CU, and the CU-UP is configured to implement a user plane function of the CU. For example, when the CU is configured to implement functions of the PDCP layer, the RRC layer, and the SDAP layer, the CU-CP is configured to implement the function of the RRC layer and a control plane function of the PDCP layer, and the CU-UP is configured to implement the function of the SDAP layer and a user plane function of the PDCP layer.

The foregoing configurations of the CU and the DU are merely examples. Alternatively, functions of the CU and the DU may be configured based on a requirement. For example, the CU or the DU may be configured to have functions of more protocol layers, or the CU or the DU may be configured to have a part of processing functions of protocol layers. For example, a part of functions of the RLC layer and functions of protocol layers above the RLC layer are set in the CU, and remaining functions of the RLC layer and functions of protocol layers below the RLC layer are set in the DU. For another example, division into functions of the CU or the DU may alternatively be performed based on service types or other system requirements. For example, division is performed based on latency. Functions whose processing time needs to satisfy a low latency requirement are set in the DU, and functions whose processing time does not need to satisfy the latency requirement are set in the CU.

The DU and the RU may cooperate to jointly implement the function of the PHY layer. One DU may be connected to one or more RUs. Functions of the DU and the RU may be configured into a plurality of manners based on a design. For example, the DU is configured to implement a baseband function, and the RU is configured to implement intermediate frequency and radio frequency functions. For another example, the DU is configured to implement a higher layer function of the PHY layer, and the RU is configured to implement a lower layer function of the PHY layer or implement the lower layer function and a radio frequency function. The higher layer function of the physical layer may include a part of functions of the physical layer, and the part of functions are closer to the MAC layer. The lower layer function of the physical layer may include another part of functions of the physical layer, and the part of functions are closer to an intermediate frequency and radio frequency side.

It should be noted that the network device may be a device or an apparatus with a chip, a device or an apparatus integrated with a circuit, or a chip, a chip system, a module, or a control unit in the device or apparatus shown above. This is not specifically limited in this application. It should be noted that, in this application, reference to the network device may mean the network device, or may mean a chip, a functional module, an integrated circuit, or the like that completes the method provided in this application in the network device. This is not specifically limited in this application.

Optionally, a common rank enhancement network architecture further includes a meta-surface that serves as an intermediate node, configured to implement a forwarding function similar to relay or integrated access and backhaul (IAB). For example, FIG. 2 is a diagram of a system of a rank enhancement solution. The system includes a network device 110, a terminal 120, and a meta-surface 130, and the meta-surface 130 serves as an intermediate node to implement a forwarding function. It is assumed that a channel between the network device 110 and the terminal 120 is represented as H0, a channel between the network device 110 and the meta-surface 130 is represented as H1, and a channel between the meta-surface 130 and the terminal 120 is represented as H2. Downlink transmission is used as an example, and a received signal satisfies Formula (1):

Y=H0+H1*W*H2 (1)

Y represents the received signal, and W represents a weighting coefficient matrix of the meta-surface. Therefore, in comparison with the conventional H0 channel, the meta-surface provides an additional H1*W*H2 channel to improve a communication rank. However, in a scenario in which the meta-surface serves as an intermediate node, a signal-to-noise ratio (SNR) performance gain of a user does not decrease sharply only when quality of a direct channel (for example, H0) is poor or channel gains of cascaded channels (for example, H1 and H2) and a direct channel are comparable. Consequently, a gain scenario of the existing rank enhancement solution is limited.

To resolve the problem that the gain scenario of the existing rank enhancement solution is limited, this application provides a corresponding technical solution. A first apparatus and a second apparatus exchange a rank enhancement effective interval by using first indication information, so that a transmission rank can be improved based on a meta-surface and a difference between responses for different multipath angles, and a system capacity can be improved. For details, refer to related descriptions in the following embodiments.
II. Communication method provided in this application:
1. First type of communication method provided in this application (a first apparatus includes a meta-surface, a second apparatus sends a reference signal, and the first apparatus performs rank enhancement channel measurement and feedback):

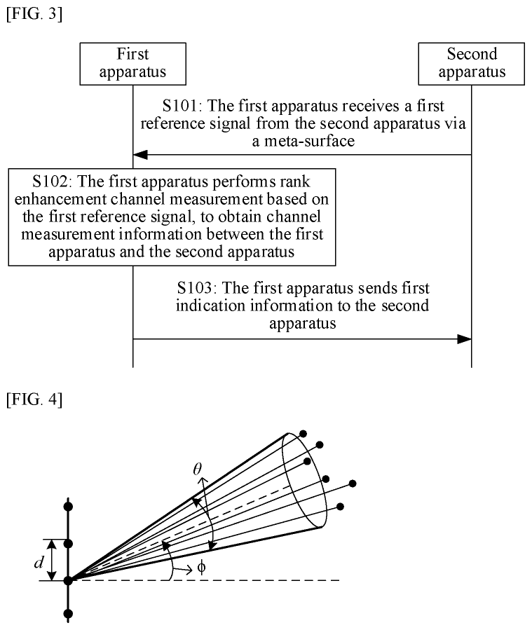

For example, FIG. 3 is a schematic flowchart of a communication method according to this application. The method may be implemented through interaction between a first apparatus and a second apparatus. For example, when the first apparatus is a network device, the second apparatus is a terminal; or when the first apparatus is a terminal, the second apparatus is a network device. The method includes the following steps.

S101: The first apparatus receives a first reference signal from the second apparatus via a meta-surface.

The second apparatus sends the first reference signal to the first apparatus. In this application, it is assumed that the first apparatus includes the meta-surface. For example, the meta-surface may be a reflection layer, and the reflection layer is attached to an antenna of the first apparatus to implement rank enhancement. Optionally, the meta-surface may be referred to as a RIS, an IRS, a LIS, a metasurface, a meta-surface, a reflecting surface, or the like. This is not limited in this application. For ease of description, these are collectively referred to as the meta-surface below. Optionally, the meta-surface may be separately deployed independent of the first apparatus, and is configured to implement a rank enhancement function. This is not limited in this application.

In a possible implementation, if the first apparatus is a terminal, and the second apparatus is a network device, the first reference signal may be a downlink reference signal, for example, a first CSI-RS. In another possible implementation, if the first apparatus is a network device, and the second apparatus is a terminal, the first reference signal may be an uplink reference signal, for example, a first SRS.

Optionally, the second apparatus sends the first reference signal to the first apparatus based on a preset periodicity. Correspondingly, the first apparatus receives, based on the preset periodicity, the first reference signal from the second apparatus via the meta-surface. Optionally, the preset periodicity may be a measurement periodicity for the first reference signal. For example, assuming that the first reference signal is a first CSI-RS, the preset periodicity may be a CSI measurement periodicity. Optionally, the measurement periodicity for the first reference signal includes a measurement periodicity and a feedback periodicity for the first reference signal. For example, assuming that the first reference signal is a first CSI-RS, the measurement periodicity for the first reference signal includes a measurement periodicity for the first CSI-RS and a feedback periodicity for CSI.

S102: The first apparatus performs rank enhancement channel measurement based on the first reference signal, to obtain channel measurement information between the first apparatus and the second apparatus.

The first apparatus includes the meta-surface. When the meta-surface of the first apparatus is used to perform the rank enhancement channel measurement, the meta-surface is weighted by using an identity weighting coefficient matrix, and when the first apparatus performs the rank enhancement channel measurement, a state of the identity weighting coefficient matrix is a meta-surface default state. Therefore, that the first apparatus performs the rank enhancement channel measurement based on the first reference signal may be: The first apparatus performs periodic rank enhancement channel measurement based on the first reference signal and a meta-surface related parameter (for example, the identity weighting coefficient matrix), to obtain the channel measurement information between the first apparatus and the second apparatus. Optionally, the identity weighting coefficient matrix includes a parameter like a vector or a matrix of a phase, an element of the vector or a diagonal element of the matrix is 1, and a value of another element of the matrix may be 0.

Optionally, a measurement periodicity of the rank enhancement channel measurement is greater than or equal to a measurement periodicity for a second reference signal, and a signal type of the second reference signal is the same as or different from a signal type of the first reference signal. For example, it is assumed that the signal types of the first reference signal and the second reference signal are the same (for example, both are CSI-RSs), the rank enhancement channel measurement may be independent of CSI measurement, and the measurement periodicity of the rank enhancement channel measurement is greater than a CSI measurement periodicity. Optionally, the measurement periodicity of the rank enhancement channel measurement includes a measurement periodicity and a feedback periodicity. For example, the measurement periodicity of the rank enhancement channel measurement performed based on the first reference signal includes a measurement periodicity for the first reference signal and a feedback periodicity for the channel measurement information (for example, a feedback periodicity for first indication information).

Optionally, the channel measurement information includes at least one of multipath angular spread information or multipath angle information. Optionally, a multipath is short for a plurality of propagation paths, and refers to a plurality of propagation paths formed based on a plurality of antennas and the meta-surface when signal transmission is performed between the first apparatus and the second apparatus. The plurality of propagation paths may include a line of sight (LOS) path and a non-line of sight (NLOS) path between the first apparatus and the second apparatus. When the meta-surface is deployed on the first apparatus or the second apparatus, the plurality of propagation paths all pass through the meta-surface.

Optionally, the multipath angle information includes at least one of the following: an average of a multipath two-dimensional incident angle and an average of a multipath two-dimensional exit angle. The average of the multipath two-dimensional incident angle or the average of the multipath two-dimensional exit angle may be an arithmetic mean of the angle, a geometric mean of the angle, a power spectrum density (PSD) root mean square, or the like. This is not limited in this application.

Optionally, the multipath angular spread information includes at least one of the following: multipath azimuth spread of arrival angle (ASA), multipath zenith spread of arrival angle (ZSA), multipath azimuth spread of departure angle (ASD), and multipath zenith spread of departure angle (ZSD). The multipath angular spread information may be defined as a maximum included angle between a plurality of paths in a cluster, or second-order central moment information of a multipath power angular spectrum (PAS).

Optionally, the multipath angle information may include an average of a multipath two-dimensional incident angle and/or an average of a multipath two-dimensional exit angle (in this case, the multipath angle information may be referred to as a multipath angle for short). The multipath angular spread information may include at least one of ASA/ZSA/ASD/ZSD (in this case, the multipath angular spread information may be referred to as multipath angular spread for short). Optionally, the multipath angle information is a type of indication information (for example, 2-bit indication information), and this type of indication information indicates the average of the multipath two-dimensional incident angle and/or the average of the multipath two-dimensional exit angle (that is, the multipath angle information indirectly includes the average of the multipath two-dimensional incident angle and/or the average of the multipath two-dimensional exit angle). The multipath angular spread information is another type of indication information, and this type of indication information indicates at least one of the ASA/ZSA/ASD/ZSD (that is, the multipath angular spread information indirectly includes at least one of the ASA/ZSA/ASD/ZSD).

For example, FIG. 4 is a diagram of multipath angle information and multipath angular spread information according to this application. A plurality of solid lines in FIG. 4 may be considered as a plurality of propagation paths, and the plurality of propagation paths form a cluster, as shown in the cone in FIG. 4. φ is an included angle between the horizontal dashed line and the center line of the cone in FIG. 4 (namely, an average of a multipath two-dimensional angle), and may represent the multipath angle information. θ is a maximum included angle between the plurality of paths in the cluster, and may represent the multipath angular spread information. Optionally, if the multipath angular spread information is second-order central moment information of a multipath PAS, a process of deriving the multipath angular spread information based on θ satisfies Formula (2) and Formula (3):

$$\overline{θ} = \frac{{\int }_{0}^{∞} θ P ( θ ) d θ}{{\int }_{0}^{∞} P ( θ ) d θ} \qquad ( 2 )$$

$$Θ = \sqrt{\frac{{\int }_{0}^{∞} {( θ - \overline{θ} )}^{2} P ( θ ) d θ}{{\int }_{0}^{∞} P ( θ ) d θ}} \qquad ( 3 )$$

\tilde{θ} represents a PAS angle average value, and Θ represents a square root of a PAS second-order central moment (namely, the multipath angular spread information).

Optionally, the multipath angular spread information may also be referred to as angular spread information of the plurality of propagation paths, and the multipath angle information may also be referred to as angle information of the plurality of propagation paths. For example, the multipath angle information includes an average of angles of the plurality of propagation paths, and the multipath angular spread information includes the maximum included angle between the plurality of paths in the cluster that include the plurality of propagation paths.

Optionally, the channel measurement information further includes at least one of a transmit antenna dimension or a receive antenna dimension. The transmit antenna dimension or the receive antenna dimension may be divided into a vertical dimension M and a horizontal dimension N for separate consideration. Optionally, the transmit antenna dimension and/or the receive antenna dimension are/is used to determine an antenna beam width, and therefore may affect the multipath angular spread information and the multipath angle information.

S103: The first apparatus sends first indication information to the second apparatus, and correspondingly, the second apparatus receives the first indication information.

The first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

For the multipath angular spread information and/or the multipath angle information, refer to the foregoing corresponding descriptions. Details are not described herein again. The following describes the rank enhancement effective mode and the rank enhancement effective threshold with reference to the multipath angular spread information and/or the multipath angle information.

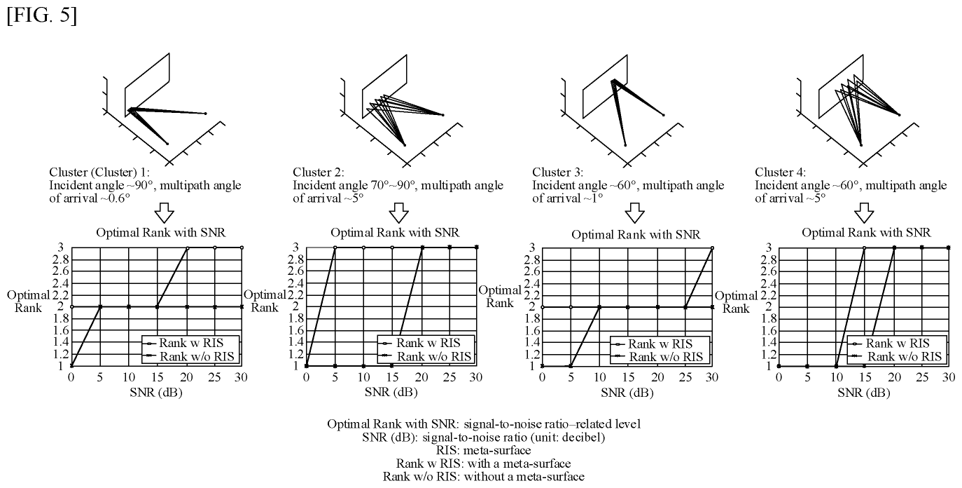

The rank enhancement effective threshold includes at least one of the following: a reference signal received power (RSRP) threshold, a signal-to-noise ratio (SNR) threshold, a signal-to-interference-plus-noise ratio (SINR) threshold, a channel quality indicator (CQI) index threshold, or a modulation and coding scheme (MCS) index threshold. In addition, the rank enhancement effective threshold is related to at least one of the multipath angular spread information or the multipath angle information. For example, FIG. 5 is a diagram of a relationship between multipath angle information and a signal-to-noise ratio according to this application. FIG. 5 includes four clusters, and each cluster includes a plurality of paths. For example, it is assumed that features of a cluster 1 are as follows: an incident angle ranges from 0° to 90°, a quantity of a plurality of paths is 15, a multipath angle of arrival ranges from 0° to 0.6°, and an area of a cluster scattering surface is 0.44 m (m)×0.88 m; features of a cluster 2 are as follows: an incident angle ranges from 70° to 90°, a quantity of a plurality of paths is 15, a multipath angle of arrival ranges from 0° to 5°, and an area of a cluster scattering surface is 4 m×2 m; features of a cluster 3 are as follows: an incident angle ranges from 0° to 60°, a quantity of a plurality of paths is 15, a multipath angle of arrival ranges from 0° to 1°, and an area of a cluster scattering surface is 0.88 m×0.44 m; and features of a cluster 4 are as follows: an incident angle ranges from 0° to 60°, a quantity of a plurality of paths is 15, a multipath angle of arrival ranges from 0° to 5°, and an area of a cluster scattering surface is 4 m×2 m. In addition, assuming that a meta-surface weighting coefficient matrix W is a random complex matrix, different paths are considered to be multiplied by different matrices W respectively. Based on the foregoing assumption, signal-to-noise ratio-related levels respectively corresponding to the clusters 1 to 4 may be deduced, as shown in FIG. 5. As the incident angle and the multipath angle of arrival change, signal-to-noise ratio distribution areas corresponding to ranks of signals reflected via the meta-surface or signals not reflected via the meta-surface are different. Therefore, different multipath angular spread information and/or multipath angle information correspond/corresponds to different rank enhancement signal-to-noise ratio threshold intervals, so that it can be determined, based on the signal-to-noise ratio threshold intervals, that CSI measurement and data transmission are performed based on an enhanced rank (in other words, the CSI measurement and the data transmission are performed based on a corresponding meta-surface weighting coefficient matrix W). Optionally, when the rank enhancement effective threshold is another threshold like an RSRP threshold or an SINR threshold, a relationship between the rank enhancement effective threshold and the multipath angular spread information and/or the multipath angle information is similar. This is not limited in this application.

The rank enhancement effective mode indicates that a rank enhancement effective interval is an open interval or a closed interval, and the rank enhancement effective interval is an open interval or a closed interval determined based on the rank enhancement effective threshold. For example, the rank enhancement effective mode includes at least two modes: an open interval mode and/or a closed interval mode. Optionally, the open interval mode may be further divided into a unilateral open interval or a bilateral open interval. For example, the unilateral open interval may be represented as [, Δ₁] or [Δ₂,], and the bilateral open interval may be represented as [, Δ₁]∪[Δ₂,], where Δ₁ or Δ₂ represents a threshold. The closed interval may be represented as [Δ₁, Δ₂], and it is assumed that Δ₁<Δ₂. Optionally, Δ₁ or Δ₂ may be any one of the rank enhancement effective thresholds described above, for example, an SNR threshold or an RSRP threshold. This is not limited in this application.

Optionally, the rank enhancement effective interval is an SNR interval, an SINR interval, or an RSRP interval. Optionally, when reference signal measurement is performed between the first apparatus and the second apparatus, for example, when CSI measurement is performed between the first apparatus and the second apparatus, information such as an SNR/SINR/RSRP may be obtained through measurement. If an SNR/SINR/RSRP value in a channel measurement result belongs to the rank enhancement effective interval, for example, if the SNR value obtained through measurement belongs to a rank enhancement SNR effective interval, it indicates that a current network scenario satisfies a requirement of the rank enhancement effective interval, and a rank enhancement operation can be performed. If CSI measurement and data transmission are related subsequently, the subsequent CSI measurement and data transmission are performed based on an enhanced rank, so that a case in which performing rank enhancement in some network scenarios instead causes a decrease in a system performance gain is avoided.

Optionally, the rank enhancement effective mode is indicated by at least two bits. For example, the rank enhancement effective mode may be implemented by using at least two bits in an independent information element, or may be implemented by using at least two reserved bits in an existing information element. A specific implementation is shown in Table 2.

TABLE 2
Table of the rank enhancement effective mode

| Mode | Type |
|---|---|
| 0 | [Δ₁, Δ₂] |
| 1 | [,Δ₁] ∪ [Δ₂,] |
| 2 | [,Δ₁] |
| 3 | [Δ₂,] |

Four states shown in Table 2 may be indicated by at least two bits. For example, the first indication information indicates a mode in Table 2, and the rank enhancement effective mode may be determined with reference to Table 2. Alternatively, the first indication information indicates a type in Table 2, and the rank enhancement effective mode may be directly determined.

Optionally, the rank enhancement effective threshold includes at least one of a maximum value or a minimum value of the rank enhancement effective interval; or the rank enhancement effective threshold includes a first value and a duration unit length, and the first value and the duration unit length are used to determine at least one of a maximum value or a minimum value of the rank enhancement effective interval. For example, the first indication information indicates the rank enhancement effective threshold, and may indicate at least one of the maximum value or the minimum value of the rank enhancement effective interval (for example, indicate a value of Δ₁ and/or Δ₂); or the first indication information indicates the first value (assuming that the first value is α) and the duration unit length (assuming that the duration unit length is β), and a value of Δ₁ and/or Δ₂ may be determined based on α and β (for example, Δ₁=α−β, Δ₂=α+β). Optionally, a specific implementation of determining the rank enhancement effective threshold based on the first value and the duration unit length is not limited in this application.

In a possible implementation, when the first indication information indicates the first information, the first indication information indicates at least one of the multipath angular spread information or the multipath angle information. In this implementation, the first apparatus and the second apparatus predefine a mapping relationship or a function relationship. In this way, the rank enhancement effective mode and the rank enhancement effective threshold can be determined based on the first information and the predefined mapping relationship or function relationship, so that the rank enhancement effective interval is determined. The following describes possible mapping relationships or function relationships.
(1) The first information is related to a first mapping relationship, a second mapping relationship, or a third mapping relationship.

In a possible implementation, the first information includes at least one piece of multipath angular spread information, and the first mapping relationship includes a plurality of rank enhancement effective modes and a plurality of rank enhancement effective thresholds corresponding to a plurality of pieces of multipath angular spread information. Optionally, based on the first mapping relationship, it can be deduced that the rank enhancement effective mode and the rank enhancement effective threshold are related to at least one of the multipath angular spread information or the multipath angle information. For example, Table 3 is a table of the first mapping relationship, and includes a plurality of pieces of multipath angular spread information, a plurality of rank enhancement effective modes, and a plurality of rank enhancement effective thresholds.

TABLE 3
Table of the first mapping relationship

| | | Rank | Rank | Rank |
|---|---|---|---|---|
| | | enhancement | enhancement | enhancement |
| | | effective | effective | effective |
| Index | Parameter | mode | threshold 1 | threshold 2 |
| 1 | Θ₁ | 1 | 0 | 25 |
| 2 | Θ₂ | 2 | 10 | 20 |
| . . . | . . . | . . . | . . . | . . . |

Parameters in Table 3 include multipath angular spread information. For example, Θ₁ and Θ₂ represent a plurality of pieces of different multipath angular spread information. Θ₁ corresponds to the rank enhancement effective mode 1 (namely, the mode 1 in Table 2, where the type of the rank enhancement effective interval is the bilateral open interval [, Δ₁]∪[Δ₂,]), and Θ₁ corresponds to the rank enhancement effective thresholds 1 and 2, which are respectively 0 and 25. With reference to the foregoing information, it can be deduced that a rank enhancement effective interval corresponding to Θ₁ is [,0]∪[25,]. Similarly, Θ₂ corresponds to the rank enhancement effective mode 2 (namely, the mode 2 in Table 2, where the type of the rank enhancement effective interval is the unilateral open interval [, Δ₁]), and Θ₂ corresponds to the rank enhancement effective thresholds 1 and 2, which are respectively 10 and 20. With reference to the foregoing information, it can be deduced that a rank enhancement effective interval corresponding to Θ₂ is [,10] or [,20]. Therefore, when the first indication information indicates the first information (including at least one piece of multipath angular spread information), the first apparatus may determine, based on the first information and with reference to the first mapping relationship shown in Table 3, a rank enhancement effective interval corresponding to the multipath angular spread information. In this way, both the first apparatus and the second apparatus use the same rank enhancement effective interval to perform rank enhancement channel measurement. For example, if the first indication information indicates the multipath angular spread information Θ₁, after receiving the first indication information, the second apparatus obtains the corresponding rank enhancement effective mode 1 and rank enhancement effective thresholds 0 and 25 by looking up Table 3 based on Θ₁, so that the second apparatus can determine that the rank enhancement effective interval is [,0]∪[25,].

Optionally, the first mapping relationship shown in Table 3 is merely an example. The parameters, the rank enhancement effective modes, and the rank enhancement effective thresholds in the first mapping relationship may be in one-to-one correspondence, may be in a one-to-many relationship (for example, the parameter Θ₁ may further correspond to the rank enhancement effective mode 1 and the rank enhancement effective thresholds 5 and 20), or may be in a many-to-one relationship (for example, the parameter Θ₁ may further correspond to the rank enhancement effective mode 2 and the rank enhancement effective thresholds 10 and 20, that is, the parameters Θ₁ and Θ₂ correspond to the same rank enhancement effective mode and the same rank enhancement effective thresholds). This is not limited in this application.

In another possible implementation, the first information includes at least one group of multipath angular spread information and multipath angle information, and the second mapping relationship includes a plurality of rank enhancement effective modes and a plurality of rank enhancement effective thresholds corresponding to a plurality of groups of multipath angular spread information and multipath angle information. For example, Table 4 is a table of the second mapping relationship, and includes a plurality of groups of multipath angular spread information and multipath angle information, a plurality of rank enhancement effective modes, and a plurality of rank enhancement effective thresholds.

TABLE 4
Table of the second mapping relationship

| | | Rank | Rank | Rank |
|---|---|---|---|---|
| | | enhancement | enhancement | enhancement |
| | | effective | effective | effective |
| Index | Parameter | mode | threshold 1 | threshold 2 |
| 1 | (Θ₁, φ₁) | 1 | 0 | 25 |
| 2 | (Θ₂, φ₂) | 2 | 10 | 20 |
| . . . | . . . | . . . | . . . | . . . |

Parameters in Table 4 include multipath angular spread information and multipath angle information. For example, (Θ₁, φ₁) and (Θ₂, φ₂) represent a plurality of groups of different multipath angular spread information and multipath angle information. (Θ₁, φ₁) corresponds to the rank enhancement effective mode 1 (namely, the mode 1 in Table 2, where the type of the rank enhancement effective interval is the bilateral open interval [,Δ₁]∪[Δ₂,]), and (Θ₁, φ₁) corresponds to the rank enhancement effective thresholds 1 and 2, which are respectively 0 and 25. With reference to the foregoing information, it can be deduced that a rank enhancement effective interval corresponding to (Θ₁, φ₁) is [,0]∪[25,]. Similarly, (Θ₂, φ₂) corresponds to the rank enhancement effective mode 2 (namely, the mode 2 in Table 2, where the type of the rank enhancement effective interval is the unilateral open interval [, Δ₁]), and (Θ₂, φ₂) corresponds to the rank enhancement effective thresholds 1 and 2, which are respectively 10 and 20. With reference to the foregoing information, it can be deduced that a rank enhancement effective interval corresponding to (Θ₂, φ₂) is [,10] or [,20]. Therefore, when the first indication information indicates the first information (including at least one group of multipath angular spread information and multipath angle information), a rank enhancement effective interval corresponding to the multipath angular spread information and the multipath angle information may be determined based on the first information and with reference to the second mapping relationship shown in Table 4. In this way, both the first apparatus and the second apparatus use the same rank enhancement effective interval to perform rank enhancement channel measurement. For example, if the first indication information indicates the multipath angular spread information and multipath angle information (Θ₁, φ₁), after receiving the first indication information, the second apparatus obtains the corresponding rank enhancement effective mode 1 and rank enhancement effective thresholds 0 and 25 by looking up Table 4 based on (Θ₁, φ₁), so that the second apparatus can determine that the rank enhancement effective interval is [,0]∪[25,]. It may be understood that a difference between the second mapping relationship and the first mapping relationship lies in that the parameters of the second mapping relationship further include the multipath angle information, and meanings of other variables in Table 4 are the same as those in Table 3.

Optionally, the second mapping relationship shown in Table 4 is merely an example. The parameters, the rank enhancement effective modes, and the rank enhancement effective thresholds in the second mapping relationship may be in one-to-one correspondence, may be in a one-to-many relationship (for example, the parameter (Θ₁, φ₁) may further correspond to the rank enhancement effective mode 1 and the rank enhancement effective thresholds 5 and 20), or may be in a many-to-one relationship (for example, the parameter (Θ₁, φ₁) may further correspond to the rank enhancement effective mode 2 and the rank enhancement effective thresholds 10 and 20, that is, the parameters (Θ₁, φ₁) and (Θ₂, φ₂) correspond to the same rank enhancement effective mode and the same rank enhancement effective thresholds). This is not limited in this application.

In still another possible implementation, the first information includes at least one group of multipath angular spread information and multipath angle information, and a transmit antenna dimension of the first reference signal, and the third mapping relationship includes a plurality of rank enhancement effective modes and a plurality of rank enhancement effective thresholds corresponding to a plurality of groups of multipath angular spread information and multipath angle information, and the transmit antenna dimension of the first reference signal. For example, Table 5 is a table of the third mapping relationship, and includes a plurality of groups of multipath angular spread information and multipath angle information, a plurality of rank enhancement effective modes, and a plurality of rank enhancement effective thresholds.

TABLE 5
Table of the third mapping relationship

| | | | Rank | Rank | Rank |
|---|---|---|---|---|---|
| | | | enhancement | enhancement | enhancement |
| | | | effective | effective | effective |
| Index | Parameter | | mode | threshold 1 | threshold 2 |
| 1 | M < M1 | (Θ₁, φ₁) | 1 | 0 | 25 |
| | M > M1 | (Θ₂, φ₂) | 2 | 10 | 20 |
| 2 | M > M1 | (Θ₃, φ₃) | 2 | 15 | 25 |
| . . . | . . . | . . . | . . . | . . . | . . . |

Parameters in Table 5 include multipath angular spread information, multipath angle information, and a transmit antenna dimension. For example, (Θ₁, φ₁) and (Θ₂, φ₂) represent a plurality of groups of different multipath angular spread information and multipath angle information, each group of multipath angular spread information and multipath angle information corresponds to a vertical dimension M of a transmit antenna, and the vertical dimension M of the transmit antenna is greater than or less than the dimension M1, as shown in Table 5. Similar to Table 3 and Table 4, (Θ₁, φ₁) and the transmit antenna dimension M<M1 or M>M1 correspond to the rank enhancement effective mode 1 (namely, the mode 1 in Table 2, where the type of the rank enhancement effective interval is the bilateral open interval [, Δ₁]∪[Δ₂,]), and (Θ₁, φ₁) corresponds to the rank enhancement effective thresholds 1 and 2, which are respectively 0 and 25. With reference to the foregoing information, it can be deduced that a rank enhancement effective interval corresponding to (Θ₁, φ₁) is [,0]∪[25,]. Similarly, (Θ₂, φ₂) and the transmit antenna dimension M<M1 or M>M1 correspond to the rank enhancement effective mode 2 (namely, the mode 2 in Table 2, where the type of the rank enhancement effective interval is the unilateral open interval [,Δ₁]), and (Θ₂, φ₂) corresponds to the rank enhancement effective thresholds 1 and 2, which are respectively 10 and 20. With reference to the foregoing information, it can be deduced that a rank enhancement effective interval corresponding to (Θ₂, φ₂) is [,10] or [,20]. Similarly, (Θ₃, φ₃) and the transmit antenna dimension M>M1 correspond to the rank enhancement effective mode 2, and (Θ₃, φ₃) corresponds to the rank enhancement effective thresholds 1 and 2, which are respectively 15 and 25. With reference to the foregoing information, it can be deduced that a rank enhancement effective interval corresponding to (Θ₃, φ₃) is [,15] or [,25]. Therefore, when the first indication information indicates the first information (including at least one group of multipath angular spread information and multipath angle information, and the transmit antenna dimension of the first reference signal), a rank enhancement effective interval corresponding to the multipath angular spread information, the multipath angle information, and the transmit antenna dimension of the first reference signal may be determined based on the first information and with reference to the third mapping relationship shown in Table 5. In this way, both the first apparatus and the second apparatus use the same rank enhancement effective interval to perform rank enhancement channel measurement. For example, if the first indication information indicates the multipath angular spread information and multipath angle information (Θ₁, φ₁) and the antenna dimension M<M1, after receiving the first indication information, the second apparatus obtains the corresponding rank enhancement effective mode 1 and rank enhancement effective thresholds 0 and 25 by looking up Table 5 based on (Θ₁, φ₁) and M<M1, so that the second apparatus can determine that the rank enhancement effective interval is [,0]∪[25,]. It may be understood that a difference between the third mapping relationship and the second mapping relationship lies in that the parameters of the third mapping relationship further include the transmit antenna dimension, and meanings of other variables in Table 5 are the same as those in Table 4.

Optionally, the third mapping relationship shown in Table 5 is merely an example. The parameters, the rank enhancement effective modes, and the rank enhancement effective thresholds in the third mapping relationship may be in one-to-one correspondence, may be in a one-to-many relationship (for example, the parameter (Θ₁, φ₁) and M<M1 may further correspond to the rank enhancement effective mode 1 and the rank enhancement effective thresholds 5 and 20), or may be in a many-to-one relationship (for example, the parameter (Θ₁, φ₁) and M<M1 may further correspond to the rank enhancement effective mode 2 and the rank enhancement effective thresholds 10 and 20, that is, the parameter (Θ₁, φ₁) and M<M1 and the parameter (Θ₂, φ₂) and M<M1 correspond to the same rank enhancement effective mode and the same rank enhancement effective thresholds). This is not limited in this application.

Optionally, based on the first mapping relationship, the second mapping relationship, or the third mapping relationship, it can be deduced that the rank enhancement effective mode and the rank enhancement effective threshold are related to at least one of the multipath angular spread information or the multipath angle information. Optionally, the first mapping relationship, the second mapping relationship, or the third mapping relationship may be a predefined mapping relationship, and it is assumed that both the first apparatus and the second apparatus may predefine the mapping relationship. Therefore, the first apparatus and the second apparatus may exchange information such as the rank enhancement effective mode, the rank enhancement effective threshold, the multipath angular spread information, and the multipath angle information by using the first indication information, so that both the first apparatus and the second apparatus can determine the corresponding rank enhancement effective interval. This helps improve a transmission rank.
(2) The first information is related to a first function relationship, a second function relationship, or a third function relationship.

Optionally, an input parameter of the first function relationship includes the multipath angular spread information, and output parameters of the first function relationship include the rank enhancement effective mode and the rank enhancement effective threshold. For example, the first function relationship satisfies Formula (4):

Y₁=f₁(Θ) (4)

f₁ represents the first function relationship, Θ represents an input parameter of the first function relationship, and Y₁ represents output parameters of the first function relationship, including the rank enhancement effective mode and the rank enhancement effective threshold (for example, the rank enhancement effective mode and the rank enhancement effective threshold shown in Table 3).

Optionally, input parameters of the second function relationship include the multipath angular spread information and the multipath angle information, and output parameters of the second function relationship include the rank enhancement effective mode and the rank enhancement effective threshold. For example, the second function relationship satisfies Formula (5):

Y₂=f₂(Θ,φ) (5)

f₂ represents the second function relationship, Θ and φ represent input parameters of the second function relationship, and Y₂ represents output parameters of the second function relationship, including the rank enhancement effective mode and the rank enhancement effective threshold (for example, the rank enhancement effective mode and the rank enhancement effective threshold shown in Table 4).

Optionally, input parameters of the third function relationship include the multipath angular spread information, the multipath angle information, and a transmit antenna dimension of the first reference signal, and output parameters of the third function relationship include the rank enhancement effective mode and the rank enhancement effective threshold. For example, the third function relationship satisfies Formula (6):

Y₃=f₃(Θ,φ,M,N) (6)

f₃ represents the third function relationship, Θ, φ, M, and N represent input parameters of the third function relationship (for example, M is a vertical dimension of a transmit antenna, and N is a horizontal dimension of the transmit antenna), and Y₃ represents output parameters of the third function relationship, including the rank enhancement effective mode and the rank enhancement effective threshold (for example, the rank enhancement effective mode and the rank enhancement effective threshold shown in Table 5).

In a possible implementation, when the first indication information indicates the second information, the first indication information indicates the rank enhancement effective mode and the rank enhancement effective threshold. For example, the first indication information indicates any group of threshold information (including the rank enhancement effective thresholds 1 and 2) in Table 3 to Table 5 and a rank enhancement effective mode corresponding to the group of threshold information. Optionally, in this implementation, the first indication information may indicate indexes of the rank enhancement effective mode and the rank enhancement effective threshold. For example, the first indication information indicates an index of any group of threshold information in Table 3 to Table 5, to indicate a rank enhancement effective mode and a rank enhancement effective threshold that correspond to the index. Optionally, in this implementation, the first indication information may indicate the rank enhancement effective mode, the first value, and the duration unit length. For example, the first indication information indicates any mode in Table 2, the first value, and the duration unit length (the rank enhancement effective threshold may be obtained through calculation in a manner described above), to indicate a corresponding rank enhancement effective mode and rank enhancement effective threshold.

In a possible implementation, when the first indication information indicates the second information, the rank enhancement effective threshold may be a channel quality indicator index threshold or a modulation and coding scheme index threshold, and one group of channel quality indicator index thresholds or modulation and coding scheme index thresholds corresponds to one group of signal-to-noise ratio thresholds, one group of signal-to-interference-plus-noise ratio thresholds, or one group of reference signal received power thresholds. For example, with reference to descriptions in a protocol standard, one CQI index may correspond to one SNR value by default. Assuming that a group of CQI index thresholds includes 3 and 10, SNR thresholds corresponding to the group of CQI index thresholds may be 10 and 25, in other words, one group of channel quality indicator index thresholds (3 and 10) corresponds to one group of signal-to-noise ratio thresholds (10 and 25). In this implementation, different from Table 3 to Table 5 described above, reference may be made to a CQI parameter table or an MCS parameter table in an existing protocol. The first indication information indicates a CQI index threshold in the CQI parameter table or an MCS index threshold in the MCS parameter table. For example, Table 6 is a CQI parameter table, and includes a CQI index and a corresponding parameter.

TABLE 6
CQI parameter table

| | | Code rate * | |
|---|---|---|---|
| | Modulation | 1024 | Coding |
| CQI | scheme | (code rate * | efficiency |
| index | (modulation) | 1024) | (efficiency) |

| | |
|---|---|
| 0 | Out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

QPSK is quadrature phase shift keying, and QAM is quadrature amplitude modulation. The first indication information may indicate CQI index thresholds (for example, the values of the CQI index in Table 6), for example, indicate that the CQI index thresholds are 3 and 10, and indicate that the rank enhancement effective mode is the mode 0 ([Δ₁, Δ₂]) in Table 2. In this case, it can be deduced that a rank enhancement effective interval corresponding to the rank enhancement effective mode and the rank enhancement effective threshold indicated by the first indication information is [3,10]. The rank enhancement channel measurement may be performed based on the rank enhancement effective interval, Table 6, and the first reference signal. Similarly, the MCS parameter table also includes an MCS index and an MCS-related parameter, and the first indication information may indicate an MCS index threshold and a rank enhancement effective mode. For a specific implementation, refer to descriptions of the CQI. Details are not described herein again. Optionally, in this implementation, the second apparatus only needs to receive the CQI based on a CSI feedback in the measurement periodicity of the rank enhancement channel measurement, and does not need to newly define the rank enhancement effective mode and the rank enhancement effective threshold shown in Table 3 to Table 5. This simplifies a processing procedure.

In a possible implementation, the first indication information indicates only the rank enhancement effective mode. For example, assuming that the first apparatus and the second apparatus predefine rank enhancement effective thresholds, and assuming that the rank enhancement effective thresholds are merely several default values (for example, it is assumed that only two default values 10 dB and 30 dB are defined in the protocol for the SNR), Table 2 may be converted into a correspondence between a rank enhancement effective mode and a default rank enhancement effective threshold, as shown in Table 7.

TABLE 7
Table of the correspondence between the rank enhancement effective
mode and the default rank enhancement effective threshold

| Mode | Type |
|---|---|
| 0 | [10, 30] |
| 1 | [,10] ∪ [30,] |
| 2 | [,10] |
| 3 | [30,] |

Optionally, four states shown in Table 7 may be indicated by at least two bits. For example, the first indication information indicates a mode in Table 7, and the rank enhancement effective mode may be determined with reference to Table 7. Alternatively, the first indication information indicates a type in Table 7, to directly indicate the rank enhancement effective mode. It can be learned that in this implementation, the first indication information may indicate only the rank enhancement effective mode. With reference to the preset Table 7, the first apparatus and the second apparatus may determine the rank enhancement effective mode and the rank enhancement effective threshold, to determine the rank enhancement effective interval.

Optionally, sending the first indication information by the first apparatus to the second apparatus may be periodically sending the first indication information (for example, sending the first indication information based on the measurement periodicity and the feedback periodicity of the rank enhancement channel measurement), or aperiodically sending the first indication information (for example, if multipath angles change after the terminal moves, the first indication information may be resent). This is not limited in this application.

Optionally, a signaling format and a bearer channel of interaction information (for example, the reference signal and the first indication information) in S101 to S103 are not limited in this application. For example, if the first apparatus is a terminal, and the second apparatus is a base station, it is assumed that the first reference signal is a first CSI-RS, and the first reference signal may be carried on a PDSCH; and the first indication information may be an RRC message, and the first indication information is carried on a PUSCH. It may be understood that the foregoing example is merely an example.

Optionally, this embodiment further includes the following procedure: The first apparatus updates the weighting coefficient matrix of the meta-surface based on the first indication information. For example, the first apparatus confirms a rank enhancement operation based on the first indication information, and change or update of the weighting coefficient of the meta-surface may be implemented based on the following processes: The first apparatus receives at least one measurement reference signal via the meta-surface, where each measurement reference signal uses a different meta-surface weighting coefficient (matrix or vector). The first apparatus obtains, through measurement, a measurement reference signal having an indicator like a maximum SNR/RSRP, determines a meta-surface weighting coefficient corresponding to the measurement reference signal, and updates the weighting coefficient matrix of the meta-surface based on the meta-surface weighting coefficient. Optionally, the first apparatus may further send, to the second apparatus, the meta-surface weighting coefficient corresponding to the measurement reference signal.

Optionally, this embodiment further includes the following procedure: The first apparatus receives the second reference signal from the second apparatus via the meta-surface. The first apparatus performs reference signal measurement based on the second reference signal, and feeds back channel state information. The first apparatus and the second apparatus perform data transmission, and the like. For example, channel measurement and channel state information feedback are performed between the first apparatus and the second apparatus based on the measurement periodicity for the second reference signal. In this case, the first apparatus does not use an identity matrix as the weighting coefficient matrix of the meta-surface.

In this embodiment, the meta-surface directly covers the first apparatus, or covers the vicinity of the first apparatus in the near field with an extremely small spacing. The plurality of propagation paths are separated by using a reflection characteristic of the meta-surface, or spatial isolation of the plurality of propagation paths is improved. In addition, the first apparatus may obtain information such as the multipath angular spread information and the multipath angle information through rank enhancement channel measurement, and the first apparatus and the second apparatus may exchange the rank enhancement effective interval in an explicit or implicit manner (for example, exchange at least one of the multipath angular spread information or the multipath angle information, or exchange information such as the rank enhancement effective mode and the rank enhancement effective threshold), so that the transmission rank can be improved based on the meta-surface and a difference between responses for different multipath angles, and a system capacity can be improved.
2. Second type of communication method provided in this application (a first apparatus includes a meta-surface, the first apparatus sends a reference signal, and a second apparatus receives the reference signal, and performs rank enhancement channel measurement and feedback):

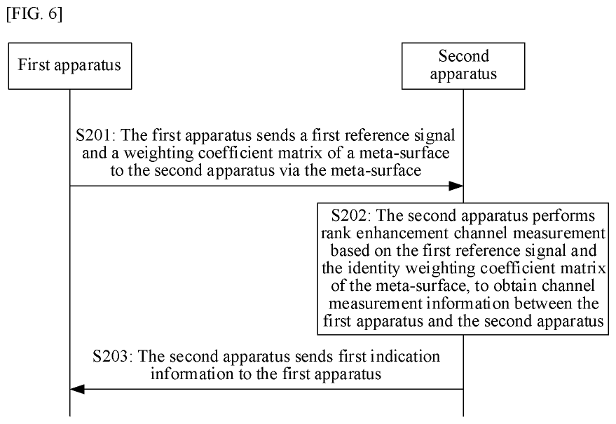

For example, FIG. 6 is a schematic flowchart of another communication method according to this application. The method may be implemented through interaction between a first apparatus and a second apparatus. For example, when the first apparatus is a network device, the second apparatus is a terminal; or when the first apparatus is a terminal, the second apparatus is a network device. The method includes the following steps.

S201: The first apparatus sends a first reference signal and a weighting coefficient matrix of a meta-surface to the second apparatus via the meta-surface, and correspondingly, the second apparatus receives the first reference signal and the weighting coefficient matrix of the meta-surface from the first apparatus.

The first apparatus includes the meta-surface. For example, the meta-surface may be a reflection layer, and the reflection layer is attached to an antenna of the first apparatus to implement rank enhancement. In addition, the first apparatus sends the first reference signal to the second apparatus via the meta-surface, so that the sent first reference signal may be transmitted to the second apparatus through a plurality of paths generated by the meta-surface, to implement rank enhancement. Optionally, for descriptions of the first reference signal, refer to corresponding descriptions in S101. Details are not described herein again.

Optionally, the first apparatus sends, based on a preset periodicity, the first reference signal to the second apparatus via the meta-surface. Correspondingly, the second apparatus receives the first reference signal from the first apparatus based on the preset periodicity. Optionally, the preset periodicity may be a measurement periodicity for the first reference signal. For example, assuming that the first reference signal is a first CSI-RS, the preset periodicity may be a CSI measurement periodicity. Optionally, the measurement periodicity for the first reference signal includes a measurement periodicity and a feedback periodicity for the first reference signal. For example, assuming that the first reference signal is a first CSI-RS, the measurement periodicity for the first reference signal includes a measurement periodicity for the first CSI-RS and a feedback periodicity for CSI.

It may be understood that, a difference between this embodiment and the embodiment in FIG. 3 lies in that the first apparatus in this embodiment includes the meta-surface and is a transmit end of the first reference signal, and the second apparatus is a receive end of the first reference signal. Assuming that the second apparatus does not include a meta-surface, to implement rank enhancement channel measurement between the second apparatus and the first apparatus, the first apparatus sends the weighting coefficient matrix of the meta-surface to the second apparatus, so that the second apparatus can perform rank enhancement channel measurement based on the first reference signal and the weighting coefficient matrix of the meta-surface. Optionally, for the weighting coefficient matrix of the meta-surface, refer to corresponding descriptions in S102. Details are not described herein again.

S202: The second apparatus performs rank enhancement channel measurement based on the first reference signal and the identity weighting coefficient matrix of the meta-surface, to obtain channel measurement information between the first apparatus and the second apparatus.

Although the second apparatus does not include the meta-surface, the second apparatus has obtained the first reference signal and the identity weighting coefficient matrix of the meta-surface attached to the first apparatus, and can perform the rank enhancement channel measurement to obtain the channel measurement information. For descriptions of the channel measurement information, refer to corresponding descriptions in S102, for example, the channel measurement information including at least one of the multipath angular spread information or the multipath angle information, and descriptions of the multipath angular spread information and the multipath angle information. Details are not described herein again.

S203: The second apparatus sends first indication information to the first apparatus, and correspondingly, the first apparatus receives the first indication information.

The first indication information indicates at least one of first information or second information. For the first indication information, the first information, the second information, a mapping relationship or a function relationship associated with the first information, and a specific feedback manner of the first indication information, refer to corresponding descriptions in S103. For example, for descriptions of a rank enhancement effective mode, a rank enhancement effective threshold, and a rank enhancement effective interval, and related descriptions of Table 2 to Table 7, Formula (4) to Formula (6), and the like, refer to corresponding descriptions in S103. Details are not described herein again.

In this embodiment, the second apparatus is the receive end of the first reference signal, the first apparatus is the transmit end of the first reference signal, and the first apparatus includes the meta-surface. The second apparatus can perform, by receiving the first reference signal and the identity weighting coefficient matrix of the meta-surface, the rank enhancement channel measurement based on the first reference signal, so that the rank enhancement effective interval can be fed back to the first apparatus. This helps the first apparatus and the second apparatus improve a transmission rank and improve a system capacity.
3. Effect analysis of the first type of communication method and the second type of communication method:

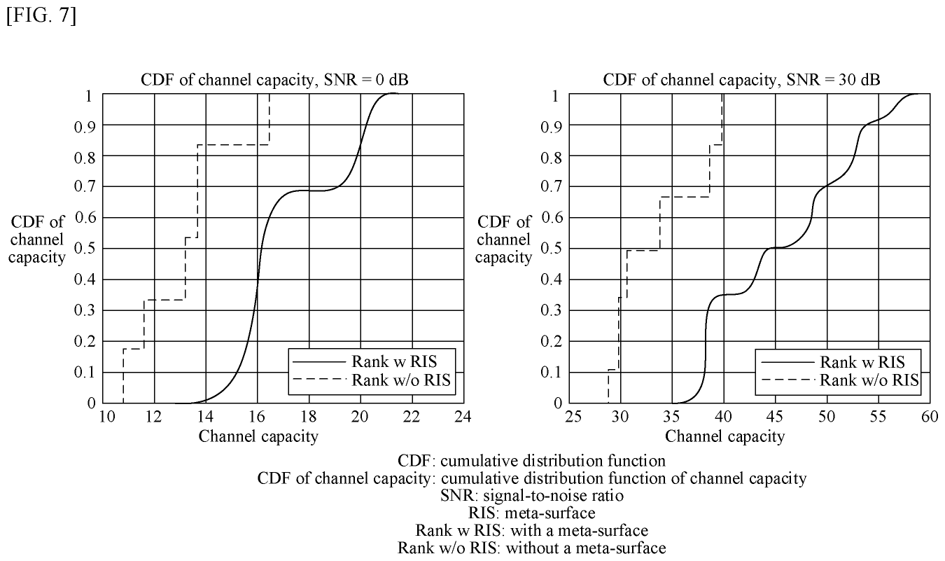

In this application, it is assumed that when rank enhancement channel measurement is performed by using the first type of communication method and the second type of communication method described above, a quantity of a plurality of paths is 15, a carrier frequency is 10 GHz, and an antenna element spacing of a meta-surface (represented by a RIS in FIG. 7) is half a wavelength (1.5 cm (cm)). In addition, it is assumed that an identity weighting coefficient matrix of the meta-surface is a random complex matrix, different paths are considered to be multiplied by different random complex matrices, and it is assumed that examples of a value of an SNR are {0 dB, 30 dB}. A diagram of a channel capacity shown in FIG. 7 may be obtained through rank enhancement channel measurement based on the meta-surface. The left part of FIG. 7 is a channel capacity change line obtained through measurement with meta-surface reflection (the solid line) or without meta-surface reflection (the dashed line) when SNR=0 dB. The right part of FIG. 7 is a channel capacity change line obtained through measurement with meta-surface reflection (the solid line) or without meta-surface reflection (the dashed line) when SNR=30 dB. It can be learned from analysis and comparison that, through meta-surface reflection and control, a transmission rank can be improved based on a difference between responses for different angles, so that a system capacity is improved.

It may be understood that to implement functions in the foregoing embodiments, a base station and a terminal include corresponding hardware structures and/or software modules for performing various functions. A person skilled in the art should be easily aware that, in this application, the units and method steps in the examples described with reference to embodiments disclosed in this application can be implemented by hardware or a combination of hardware and computer software. Whether a function is performed by hardware or hardware driven by computer software depends on particular application scenarios and design constraint conditions of the technical solutions.

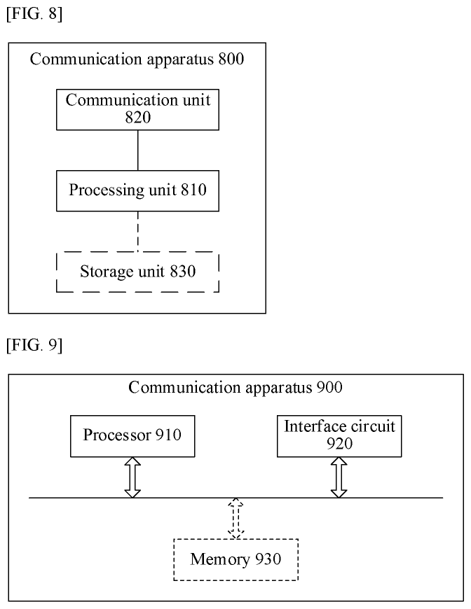

FIG. 8 and FIG. 9 are diagrams of structures of possible communication apparatuses according to embodiments of this application. These communication apparatuses may be configured to implement a function of the first apparatus or the second apparatus in the foregoing method embodiments, and therefore can also achieve the beneficial effects of the foregoing method embodiments.

As shown in FIG. 8, a communication apparatus 800 includes a processing unit 810 and a communication unit 820. The communication apparatus 800 is configured to implement a function of the first apparatus or the second apparatus in the method embodiments shown in FIG. 3 and FIG. 6. Optionally, the communication unit 820 may also be referred to as a transceiver unit. Optionally, the transceiver unit includes a sending unit and a receiving unit. The sending unit is configured to send a signal, and the receiving unit is configured to receive a signal. Optionally, the communication apparatus 800 further includes a storage unit 830, configured to store program code and/or data of the apparatus.
(1) The communication apparatus 800 may be the terminal side apparatus in the foregoing embodiments, for example, a terminal or a communication module in the terminal, or a circuit or a chip that is responsible for a communication function in the terminal.

For example, when the communication apparatus 800 is configured to implement the function of the first apparatus in the method embodiment shown in FIG. 3, the communication unit 820 is configured to receive a first reference signal from the second apparatus via a meta-surface, and the processing unit 810 is configured to perform rank enhancement channel measurement based on the first reference signal, to obtain channel measurement information between the first apparatus and the second apparatus, where the channel measurement information includes at least one of multipath angular spread information or multipath angle information. The communication unit 820 is further configured to send first indication information to the second apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

In a possible implementation, the meta-surface is weighted by using an identity weighting coefficient matrix, and a state of the identity weighting coefficient matrix of the meta-surface is a meta-surface default state. The processing unit 810 is further configured to determine the channel measurement information based on the identity weighting coefficient matrix of the meta-surface and the first reference signal.

In a possible implementation, the processing unit 810 is further configured to update the weighting coefficient matrix of the meta-surface based on the first indication information.

For another example, when the communication apparatus 800 is configured to implement the function of the first apparatus in the method embodiment shown in FIG. 6, the communication unit 820 is configured to send a first reference signal and an identity weighting coefficient matrix of a meta-surface to the second apparatus via the meta-surface, where the first reference signal and the identity weighting coefficient matrix of the meta-surface are used by the second apparatus to perform rank enhancement channel measurement. The communication unit 820 is further configured to receive first indication information from the second apparatus, where the first indication information indicates at least one of first information or second information. The first information includes at least one of multipath angular spread information or multipath angle information. The at least one of the multipath angular spread information or the multipath angle information is obtained by the second apparatus by performing the rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information.

In a possible implementation, when the first information includes at least one of the multipath angular spread information or the multipath angle information, the processing unit 810 is further configured to obtain, based on at least one of the multipath angular spread information or the multipath angle information, a rank enhancement effective mode and a rank enhancement effective threshold that correspond to the first information from at least one of a preset first mapping relationship, second mapping relationship, or third mapping relationship.

In a possible implementation, when the first information includes at least one of the multipath angular spread information or the multipath angle information, the processing unit 810 is further configured to use at least one of the multipath angular spread information or the multipath angle information as an input parameter of a function, and obtains, with reference to at least one of a preset first function relationship, second function relationship, or third function relationship, output parameters of the function, where the output parameters include a rank enhancement effective mode and a rank enhancement effective threshold that correspond to the first information.

For still another example, when the communication apparatus 800 is configured to implement the function of the second apparatus in the method embodiment shown in FIG. 3, the communication unit 820 is configured to send a first reference signal to the first apparatus. The communication unit 820 is further configured to receive first indication information from the first apparatus, where the first indication information indicates at least one of first information or second information. The first information includes at least one of multipath angular spread information or multipath angle information. The at least one of the multipath angular spread information or the multipath angle information is obtained by the first apparatus by performing rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information.

In a possible implementation, when the first information includes at least one of the multipath angular spread information or the multipath angle information, the processing unit 810 is further configured to obtain, based on at least one of the multipath angular spread information or the multipath angle information, a rank enhancement effective mode and a rank enhancement effective threshold that correspond to the first information from at least one of a preset first mapping relationship, second mapping relationship, or third mapping relationship.

In a possible implementation, when the first information includes at least one of the multipath angular spread information or the multipath angle information, the processing unit 810 is further configured to use at least one of the multipath angular spread information or the multipath angle information as an input parameter of a function, and obtains, with reference to at least one of a preset first function relationship, second function relationship, or third function relationship, output parameters of the function, where the output parameters include a rank enhancement effective mode and a rank enhancement effective threshold that correspond to the first information.

For yet another example, when the communication apparatus 800 is configured to implement the function of the second apparatus in the method embodiment shown in FIG. 6, the communication unit 820 is configured to receive a first reference signal and an identity weighting coefficient matrix of a meta-surface from the first apparatus. The processing unit 810 is configured to perform rank enhancement channel measurement based on the first reference signal and the identity weighting coefficient matrix of the meta-surface, to obtain channel measurement information between the first apparatus and the second apparatus, where the channel measurement information includes at least one of multipath angular extension or a multipath angle. The communication unit 820 is further configured to send first indication information to the first apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

For more detailed descriptions of the processing unit 810 and the communication unit 820, refer to related descriptions in the foregoing method embodiments. Details are not described herein again.

In a possible implementation, when the communication apparatus 800 is a terminal or a communication module in the terminal, a function of the processing unit 810 may be implemented by one or more processors. Specifically, the processor may include a modem chip, or a SoC or SIP chip including a modem core. The function of the communication unit 820 may be implemented by a transceiver circuit.

In a possible implementation, when the communication apparatus 800 is a circuit or a chip that is responsible for the communication function in the terminal, for example, a modem chip, or a system-on-a-chip SoC chip or a SIP chip including a modem core, the function of the processing unit 810 may be implemented by a circuit system that includes one or more processors or processor cores in the chip. The function of the communication unit 820 may be implemented by an interface circuit or a data transceiver circuit in the foregoing chip.
(2) The communication apparatus 800 may be the network side apparatus in the foregoing embodiments, for example, a base station, a communication module in the base station, or a circuit or a chip that is responsible for a communication function in the base station.

For example, when the communication apparatus 800 is configured to implement the function of the first apparatus in the method embodiment shown in FIG. 3, the communication unit 820 is configured to receive a first reference signal from the second apparatus via a meta-surface, and the processing unit 810 is configured to perform rank enhancement channel measurement based on the first reference signal, to obtain channel measurement information between the first apparatus and the second apparatus, where the channel measurement information includes at least one of multipath angular spread information or multipath angle information. The communication unit 820 is further configured to send first indication information to the second apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

In a possible implementation, the meta-surface is weighted by using an identity weighting coefficient matrix, and a state of the identity weighting coefficient matrix of the meta-surface is a meta-surface default state. The processing unit 810 is further configured to determine the channel measurement information based on the identity weighting coefficient matrix of the meta-surface and the first reference signal.

In a possible implementation, the processing unit 810 is further configured to update the weighting coefficient matrix of the meta-surface based on the first indication information.

For another example, when the communication apparatus 800 is configured to implement the function of the first apparatus in the method embodiment shown in FIG. 6, the communication unit 820 is configured to send a first reference signal and an identity weighting coefficient matrix of a meta-surface to the second apparatus via the meta-surface, where the first reference signal and the identity weighting coefficient matrix of the meta-surface are used by the second apparatus to perform rank enhancement channel measurement. The communication unit 820 is further configured to receive first indication information from the second apparatus, where the first indication information indicates at least one of first information or second information. The first information includes at least one of multipath angular spread information or multipath angle information. The at least one of the multipath angular spread information or the multipath angle information is obtained by the second apparatus by performing the rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information.

In a possible implementation, when the first information includes at least one of the multipath angular spread information or the multipath angle information, the processing unit 810 is further configured to obtain, based on at least one of the multipath angular spread information or the multipath angle information, a rank enhancement effective mode and a rank enhancement effective threshold that correspond to the first information from at least one of a preset first mapping relationship, second mapping relationship, or third mapping relationship.

In a possible implementation, when the first information includes at least one of the multipath angular spread information or the multipath angle information, the processing unit 810 is further configured to use at least one of the multipath angular spread information or the multipath angle information as an input parameter of a function, and obtains, with reference to at least one of a preset first function relationship, second function relationship, or third function relationship, output parameters of the function, where the output parameters include a rank enhancement effective mode and a rank enhancement effective threshold that correspond to the first information.

For still another example, when the communication apparatus 800 is configured to implement the function of the second apparatus in the method embodiment shown in FIG. 3, the communication unit 820 is configured to send a first reference signal to the first apparatus. The communication unit 820 is further configured to receive first indication information from the first apparatus, where the first indication information indicates at least one of first information or second information. The first information includes at least one of multipath angular spread information or multipath angle information. The at least one of the multipath angular spread information or the multipath angle information is obtained by the first apparatus by performing rank enhancement channel measurement based on the first reference signal. The second information includes a rank enhancement effective mode and a rank enhancement effective threshold, and the rank enhancement effective mode and the rank enhancement effective threshold are related to at least one of the multipath angular spread information or the multipath angle information.

In a possible implementation, when the first information includes at least one of the multipath angular spread information or the multipath angle information, the processing unit 810 is further configured to obtain, based on at least one of the multipath angular spread information or the multipath angle information, a rank enhancement effective mode and a rank enhancement effective threshold that correspond to the first information from at least one of a preset first mapping relationship, second mapping relationship, or third mapping relationship.

In a possible implementation, when the first information includes at least one of the multipath angular spread information or the multipath angle information, the processing unit 810 is further configured to use at least one of the multipath angular spread information or the multipath angle information as an input parameter of a function, and obtains, with reference to at least one of a preset first function relationship, second function relationship, or third function relationship, output parameters of the function, where the output parameters include a rank enhancement effective mode and a rank enhancement effective threshold that correspond to the first information.

For yet another example, when the communication apparatus 800 is configured to implement the function of the second apparatus in the method embodiment shown in FIG. 6, the communication unit 820 is configured to receive a first reference signal and an identity weighting coefficient matrix of a meta-surface from the first apparatus. The processing unit 810 is configured to perform rank enhancement channel measurement based on the first reference signal and the identity weighting coefficient matrix of the meta-surface, to obtain channel measurement information between the first apparatus and the second apparatus, where the channel measurement information includes at least one of multipath angular extension or a multipath angle. The communication unit 820 is further configured to send first indication information to the first apparatus, where the first indication information indicates at least one of first information or second information. The first information includes at least one of the multipath angular spread information or the multipath angle information. The second information includes a rank enhancement effective mode and a rank enhancement effective threshold, and the rank enhancement effective mode and the rank enhancement effective threshold are related to at least one of the multipath angular spread information or the multipath angle information.

For more detailed descriptions of the processing unit 810 and the communication unit 820, refer to related descriptions in the foregoing method embodiments. Details are not described herein again.

It may be understood that division into the units in the foregoing apparatus is merely logical function division. Each function may correspond to one functional unit, or two or more functions may be integrated into one functional unit. During actual implementation, all or some units may be integrated into one physical entity, or may be distributed on different physical entities. In addition, the foregoing functional unit may be implemented in a form of hardware, or may be implemented in a form of software, or may be implemented in a form of hardware in combination with software. Whether a function is performed by hardware or software depends on particular applications and design constraint conditions of the technical solutions. A person skilled in the art may use different methods to implement the described functions for each particular application, but it should not be considered that the implementation goes beyond the scope of this application.

In an example, the storage unit 830 may include a random access memory, a flash memory, a read-only memory, a programmable read-only memory, an electrically erasable programmable memory, a register, and/or the like.

As shown in FIG. 9, the communication apparatus 900 includes a processor 910 and an interface circuit 920. The processor 910 and the interface circuit 920 are coupled to each other. It may be understood that the interface circuit 920 may be a transceiver or an input/output interface. Optionally, the transceiver includes a receiver and a transmitter. Optionally, the communication apparatus 900 may further include a memory 930, configured to store instructions executed by the processor 910, or store input data required by the processor 910 to run instructions, or store data generated after the processor 910 runs the instructions. Sometimes, the interface circuit 920 may also be understood as a part of the processor 910. In this case, the communication apparatus 900 includes the processor 910.

When the communication apparatus 900 is configured to implement the methods shown in FIG. 3 and FIG. 6, the processor 910 is configured to implement a function of the processing unit 810, and the interface circuit 920 is configured to implement a function of the communication unit 820. Optionally, when the communication apparatus 900 is configured to implement the methods shown in FIG. 3 and FIG. 6, for implementations of the processor 910 and the interface circuit 920, refer to corresponding descriptions in the foregoing method embodiments. Details are not described herein again.

When the communication apparatus is a chip used in the first apparatus, the chip implements the function of the first apparatus in the foregoing method embodiments. That the chip receives information from another apparatus may be understood as that the information is first received by another module (for example, a radio frequency module or an antenna) in the first apparatus, and then sent by the module to the chip. That the chip sends information to another apparatus may be understood as that the information is first sent to another module (for example, a radio frequency module or an antenna) in the first apparatus, and then sent by the module to another network element.

When the communication apparatus is a chip used in the second apparatus, the chip implements the function of the second apparatus in the foregoing method embodiments. That the chip receives information from another apparatus may be understood as that the information is first received by another module (for example, a radio frequency module or an antenna) in the second apparatus, and then sent by the module to the chip. That the chip sends information to another apparatus may be understood as that the information is sent to another module (for example, a radio frequency module or an antenna) in the second apparatus, and then sent by the module to another network element.

In this application, that an apparatus A sends information to an apparatus B may be that A directly sends the information to B, or may be that A indirectly sends the information to B via another apparatus. Similarly, that an apparatus B receives information from an apparatus A may be that the apparatus B directly receives the information sent by the apparatus A, or may be that the apparatus B indirectly receives, via another apparatus, the information sent by the apparatus A. The apparatuses A and B herein may be network devices or terminals, or may be modules inside the network device or the terminal. Information sending and receiving may be information exchange between network devices or terminals. Information sending and receiving may alternatively be information exchange between two terminals. Information sending and receiving may alternatively be information exchange between different modules in an apparatus, for example, information exchange between a chip in a terminal and another module in the terminal.

It may be understood that, the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general purpose processor may be a microprocessor or any regular processor or the like.

The method steps in embodiments of this application may be implemented in hardware, or may be implemented in software instructions that may be executed by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a compact disc read-only memory (CD-ROM), or any other form of storage medium well-known in the art. For example, a storage medium is coupled to a processor, so that the processor can read information from the storage medium and write information into the storage medium. The storage medium may alternatively be a component of the processor. The processor and the storage medium may be disposed in an ASIC. In addition, the ASIC may be located in a base station or a terminal. Certainly, the processor and the storage medium may exist in a base station or terminal as discrete components.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer programs or instructions. When the computer programs or the instructions are loaded and executed on a computer, the procedures or functions in embodiments of this application are all or partially executed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk drive, or a magnetic tape, may be an optical medium, for example, a digital video disc, or may be a semiconductor medium, for example, a solid-state drive. The computer-readable storage medium may be a volatile or non-volatile storage medium, or may include two types of storage media: a volatile storage medium and a non-volatile storage medium.

In embodiments of this application, unless otherwise stated or there is a logic conflict, terms and/or descriptions in different embodiments are consistent and may be mutually referenced, and technical features in different embodiments may be combined into a new embodiment based on an internal logical relationship thereof.

It may be understood that various numbers in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

1. A communication method, comprising:
receiving, by a first apparatus, a first reference signal from a second apparatus via a meta-surface;
performing, by the first apparatus, rank enhancement channel measurement based on the first reference signal, to obtain channel measurement information between the first apparatus and the second apparatus, wherein the channel measurement information comprises at least one of multipath angular spread information or multipath angle information; and
sending, by the first apparatus to the second apparatus, first indication information indicating at least one of first information or second information, wherein
the first information comprises at least one of the multipath angular spread information or the multipath angle information; and
the second information comprises a rank enhancement effective mode and a rank enhancement effective threshold, and the rank enhancement effective mode and the rank enhancement effective threshold are related to at least one of the multipath angular spread information or the multipath angle information.

2. The method according to claim 1, wherein the first information is related to a first mapping relationship, a second mapping relationship, or a third mapping relationship; and
the first information comprises at least one piece of multipath angular spread information, and the first mapping relationship comprises a plurality of rank enhancement effective modes and a plurality of rank enhancement effective thresholds corresponding to a plurality of pieces of multipath angular spread information;
the first information comprises at least one group of multipath angular spread information and multipath angle information, and the second mapping relationship comprises a plurality of rank enhancement effective modes and a plurality of rank enhancement effective thresholds corresponding to a plurality of groups of multipath angular spread information and multipath angle information; or
the first information comprises at least one group of multipath angular spread information and multipath angle information, and a transmit antenna dimension of the first reference signal, and the third mapping relationship comprises a plurality of rank enhancement effective modes and a plurality of rank enhancement effective thresholds corresponding to a plurality of groups of multipath angular spread information and multipath angle information, and the transmit antenna dimension of the first reference signal.

3. The method according to claim 1, wherein the first information is related to a first function relationship, a second function relationship, or a third function relationship; and
the first information comprises at least one piece of multipath angular spread information, an input parameter of the first function relationship comprises the multipath angular spread information, and output parameters of the first function relationship comprise the rank enhancement effective mode and the rank enhancement effective threshold;
the first information comprises at least one group of multipath angular spread information and multipath angle information, input parameters of the second function relationship comprise the multipath angular spread information and the multipath angle information, and output parameters of the second function relationship comprise the rank enhancement effective mode and the rank enhancement effective threshold; or
the first information comprises at least one group of multipath angular spread information and multipath angle information, and a transmit antenna dimension of the first reference signal, input parameters of the third function relationship comprise the multipath angular spread information, the multipath angle information, and the transmit antenna dimension of the first reference signal, and output parameters of the third function relationship comprise the rank enhancement effective mode and the rank enhancement effective threshold.

4. The method according to claim 1, wherein the rank enhancement effective threshold comprises a channel quality indicator index threshold or a modulation and coding scheme index threshold, wherein
one group of channel quality indicator index thresholds or modulation and coding scheme index thresholds corresponds to one group of signal-to-noise ratio thresholds, one group of signal-to-interference-plus-noise ratio thresholds, or one group of reference signal received power thresholds.

5. The method according to claim 1, wherein the rank enhancement effective mode indicates that a rank enhancement effective interval is an open interval or a closed interval, and the rank enhancement effective mode is indicated by at least two bits.

6. The method according to claim 5, wherein the rank enhancement effective threshold comprises at least one of a maximum value or a minimum value of the rank enhancement effective interval; or
the rank enhancement effective threshold comprises a first value and a duration unit length, and the first value and the duration unit length are used to determine at least one of a maximum value or a minimum value of the rank enhancement effective interval.

7. The method according to claim 1, wherein the performing, by the first apparatus, the rank enhancement channel measurement comprises:
determining, by the first apparatus, the channel measurement information based on an identity weighting coefficient matrix of the meta-surface and the first reference signal.

8. The method according to claim 7, the method further comprising:
updating, by the first apparatus, the weighting coefficient matrix of the meta-surface based on the first indication information.

9. The method according to claim 1, wherein a measurement periodicity of the rank enhancement channel measurement is determined based on a change status of a multipath angle; and
the measurement periodicity of the rank enhancement channel measurement is greater than or equal to a measurement periodicity for a second reference signal, and a signal type of the second reference signal is the same as or different from a signal type of the first reference signal.

10. A communication method, comprising:
sending, by a first apparatus, a first reference signal and an identity weighting coefficient matrix of a meta-surface to a second apparatus via the meta-surface, wherein the first reference signal and the identity weighting coefficient matrix of the meta-surface are used by the second apparatus to perform rank enhancement channel measurement; and
receiving, by the first apparatus, first indication information from the second apparatus, wherein the first indication information indicates at least one of first information or second information, wherein
the first information comprises at least one of multipath angular spread information or multipath angle information, and the at least one of the multipath angular spread information or the multipath angle information is obtained by the second apparatus by performing the rank enhancement channel measurement; and
the second information comprises a rank enhancement effective mode and a rank enhancement effective threshold, and the rank enhancement effective mode and the rank enhancement effective threshold are related to at least one of the multipath angular spread information or the multipath angle information.

11. A communication method, comprising:
receiving, by a second apparatus, a first reference signal and an identity weighting coefficient matrix of a meta-surface from a first apparatus;
performing, by the second apparatus, rank enhancement channel measurement based on the first reference signal and the identity weighting coefficient matrix of the meta-surface, to obtain channel measurement information between the first apparatus and the second apparatus, wherein the channel measurement information comprises at least one of multipath angular spread information or multipath angle information; and
sending, by the second apparatus, first indication information to the first apparatus, wherein the first indication information indicates at least one of first information or second information, wherein
the first information comprises at least one of the multipath angular spread information or the multipath angle information; and
the second information comprises a rank enhancement effective mode and a rank enhancement effective threshold, and the rank enhancement effective mode and the rank enhancement effective threshold are related to at least one of the multipath angular spread information or the multipath angle information.

12. The method according to claim 11, wherein the first information is related to a first mapping relationship, a second mapping relationship, or a third mapping relationship; and
the first information comprises at least one piece of multipath angular spread information, and the first mapping relationship comprises a plurality of rank enhancement effective modes and a plurality of rank enhancement effective thresholds corresponding to a plurality of pieces of multipath angular spread information;
the first information comprises at least one group of multipath angular spread information and multipath angle information, and the second mapping relationship comprises a plurality of rank enhancement effective modes and a plurality of rank enhancement effective thresholds corresponding to a plurality of groups of multipath angular spread information and multipath angle information; or
the first information comprises at least one group of multipath angular spread information and multipath angle information, and a transmit antenna dimension of the first reference signal, and the third mapping relationship comprises a plurality of rank enhancement effective modes and a plurality of rank enhancement effective thresholds corresponding to a plurality of groups of multipath angular spread information and multipath angle information, and the transmit antenna dimension of the first reference signal.

13. The method according to claim 11, wherein the first information is related to a first function relationship, a second function relationship, or a third function relationship; and
the first information comprises at least one piece of multipath angular spread information, an input parameter of the first function relationship comprises the multipath angular spread information, and output parameters of the first function relationship comprise the rank enhancement effective mode and the rank enhancement effective threshold;
the first information comprises at least one group of multipath angular spread information and multipath angle information, input parameters of the second function relationship comprise the multipath angular spread information and the multipath angle information, and output parameters of the second function relationship comprise the rank enhancement effective mode and the rank enhancement effective threshold; or
the first information comprises at least one group of multipath angular spread information and multipath angle information, and a transmit antenna dimension of the first reference signal, input parameters of the third function relationship comprise the multipath angular spread information, the multipath angle information, and the transmit antenna dimension of the first reference signal, and output parameters of the third function relationship comprise the rank enhancement effective mode and the rank enhancement effective threshold.

14. The method according to claim 11, wherein the rank enhancement effective threshold comprises a channel quality indicator index threshold or a modulation and coding scheme index threshold, wherein
one group of channel quality indicator index thresholds or modulation and coding scheme index thresholds corresponds to one group of signal-to-noise ratio thresholds, one group of signal-to-interference-plus-noise ratio thresholds, or one group of reference signal received power thresholds.

15. The method according to claim 11, wherein the rank enhancement effective mode indicates that a rank enhancement effective interval is an open interval or a closed interval, and the rank enhancement effective mode is indicated by at least two bits.

16. The method according to claim 15, wherein the rank enhancement effective threshold comprises at least one of a maximum value or a minimum value of the rank enhancement effective interval; or
the rank enhancement effective threshold comprises a first value and a duration unit length, and the first value and the duration unit length are used to determine at least one of a maximum value or a minimum value of the rank enhancement effective interval.

17. The method according to claim 11, wherein a measurement periodicity for performing the rank enhancement channel measurement based on the first reference signal is determined based on a change status of a multipath angle; and
the measurement periodicity of the rank enhancement channel measurement is greater than or equal to a measurement periodicity for a second reference signal, and a signal type of the second reference signal is the same as or different from a signal type of the first reference signal.
